(19) United States
(12) Patent Application Publication
(10) Pub. No.: US 2013/0322374 A1
(43) Pub. Date: Dec. 5, 2013

(54) INTERFERENCE CONTROL FOR HETEROGENEOUS NETWORKS

(71) Applicant: InterDigital Patent Holdings, Inc., Wilmington, DE (US)

(72) Inventors: Lujing Cai, Morganville, NJ (US); Christopher Cave, Dollard-des-Ormeaux (CA); Diana Pani, Montreal (CA); Benoit Pelletier, Roxboro (CA); Paul Marinier, Brossard (CA)

(21) Appl. No.: 13/907,105

(22) Filed: May 31, 2013

Related U.S. Application Data
(60) Provisional application No. 61/653,487, filed on May 31, 2012.
(60) Provisional application No. 61/753,383, filed on Jan. 16, 2013.

(51) Int. Cl. H04W 52/24

(52) U.S. Cl. CPC H04W 52/244
USPC 370/329

(57) ABSTRACT

A wireless communication network may include multiple cells for communicating with a WTRU. One cell may be a macrocell, while another may be a small cell, such as a picocell or a femtocell. Interference control may be performed for controlling communications performed by multiple cells. Inter-cell interference in the downlink and/or uplink may be addressed by time domain resource partitioning. A control channel may be precoded separate from other uplink channels in beamforming. Multiple blank subframes may be included in communications to reduce interference with other communications on the network. Control channel power may be controlled based on WTRU measurements. Transmission power on the control channel may be adjusted based on a difference between a serving cell measurement and a non-serving cell measurement taken at the WTRU.

### CROSS-REFERENCE TO RELATED APPLICATIONS

This application claims the benefit of U.S. Provisional Patent Application No. 61/653,487, filed on May 31, 2012, and U.S. Provisional Patent Application No. 61/753,383, filed on Jan. 16, 2013, the contents of which are incorporated by reference herein in their entirety.

### BACKGROUND

Wireless data traffic has been increasing on wireless communication networks as the amount of data services that use the wireless communication network has increased. More users are using wireless communication devices that have a high demand for data. To boost system capacity and enhance coverage performance heterogeneous network (HetNet) deployments may be implemented.

A HetNet may refer to a wireless communication network that may use multiple types of access nodes in a wireless network. Each node may include one or more cells. The HetNet can use macrocells and small cells (e.g., picocells, femtocells, and/or WiFi network elements) to offer coverage in a wireless communication network. The coverage area of the macrocell may include or overlap with the coverage area of a small cell. Small cells may enable a user device to receive data at increased data rates depending on the location of the user device within the service areas.

Implementation of a HetNet in a wireless communication network may be complex and/or inefficient. As a HetNet may have multiple cells communicating within a coverage area, communications from the cells may cause interference.

### SUMMARY

Systems, methods, and apparatuses are described herein for performing interference control in a wireless communication network. The wireless communication network may be a heterogeneous network (HetNet), which may implement multiple nodes. In a HetNet, a wireless transmit/receive unit (WTRU) may perform network communications using a macrocell and/or a small cell (e.g., a picocell or a femtocell). The WTRU may receive downlink communications and/or transmit uplink communications to one or more cells in the communication network. Interference control may be performed, as described herein, relating to uplink and/or downlink communications in the communications network.

Inter-cell interference in the downlink and/or uplink may be addressed by time domain resource partitioning. A control channel may be precoded separate from other uplink channels in beamforming. A power of a control channel may be controlled based on one or more WTRU measurements. The precoding and/or power control may include using the control channel for communicating with a WTRU.

Blank subframes may be included in communications from an aggressor cell to reduce interference with other communications on the network, such as communications from a victim cell or a WTRU for example. The aggressor cell may be a cell that may create interference with a communication from a victim cell or the WTRU. Communications from the aggressor cell may include control channel communications and/or data channel communications. The blank subframes may be grouped together to create a blanking period or an almost blank frame (ABF) across the control channel and/or the data channel. The identification of the blank subframes may be communicated to the aggressor cell by the network.

Transmission power may be adjusted for network communications to overcome interference. Measurements may be taken on a downlink channel at each cell to determine an amount of power increase that may be performed for an uplink channel. A measurement may be performed on a downlink channel of a serving cell and another measurement may be performed on a downlink channel of a non-serving cell. The measurements may include a pathloss, received signal code power (RSCP), a received signal strength indication (RSSI), a chip-level signal-to-noise ratio (Ec/No), a chip-level signal-to-interference ratio (Ec/Io), and/or another quantity that may indicate signal quality. A power adjustment for an uplink channel may be determined based on a difference between the measurements. The power adjustment may be a power increase applied to the control channel of the serving cell, for example.

### BRIEF DESCRIPTION OF THE DRAWINGS

A more detailed understanding may be had from the following description, given by way of example in conjunction with the accompanying drawings.

FIG. 1A is a system diagram of an example communication system in which one or more disclosed embodiments may be implemented.

FIG. 1B is a system diagram of an example wireless transmit/receive unit (WTRU) that may be used within the communication system illustrated in FIG. 1A.

FIG. 1C is a system diagram of an example radio access network and an example core network that may be used within the communication system illustrated in FIG. 1A.

FIG. 1D is a system diagram of another example radio access network and an example core network that may be used within the communication system illustrated in FIG. 1A.

FIG. 1E is a system diagram of another example radio access network and an example core network that may be used within the communication system illustrated in FIG. 1A.

FIG. 2 is a diagram that depicts an example communication environment for performing communications using a heterogeneous network (HetNet).

FIG. 3 is a diagram that depicts another example communication environment for performing communications using a HetNet.

FIG. 4A is a diagram that depicts another example communication environment for performing communications using a HetNet.

FIG. 4B is a diagram that depicts another example communication environment for performing communications using a HetNet.

FIG. 5 is a graph that illustrates an example of an offset that may be used to implement cell range extension.

FIG. 6A is a diagram that depicts another example communication environment for performing communications using a HetNet.

FIG. 6B is a diagram that depicts a HetNet for performing communications using uplink specific beamforming.

FIG. 7 is a diagram that depicts an example communications environment for implementing a cross-carrier control channel.

FIG. 8 is a diagram that depicts an example of an unaligned subframe structure for network communications.

FIG. 9 is a diagram depicting an example of an almost blank frame (ABF) structure for network communications.

FIG. 10 is a diagram that illustrates an exemplary timing relation of communications at an aggressor cell and a victim cell.

FIG. 11 is a diagram that depicts an example of physical channels that may be involved in uplink time partitioning.

FIG. 12 is a diagram of an example subframe configuration that may be implemented for ABF coordination.

FIG. 13 is a diagram of another example subframe configuration that may be implemented for ABF coordination.

### DETAILED DESCRIPTION

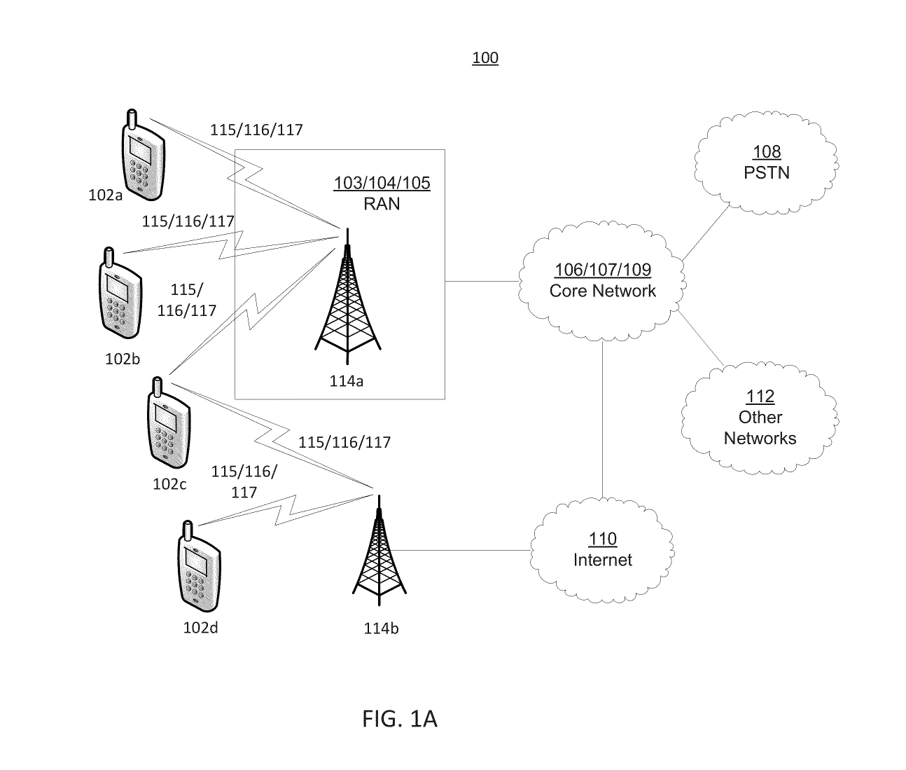

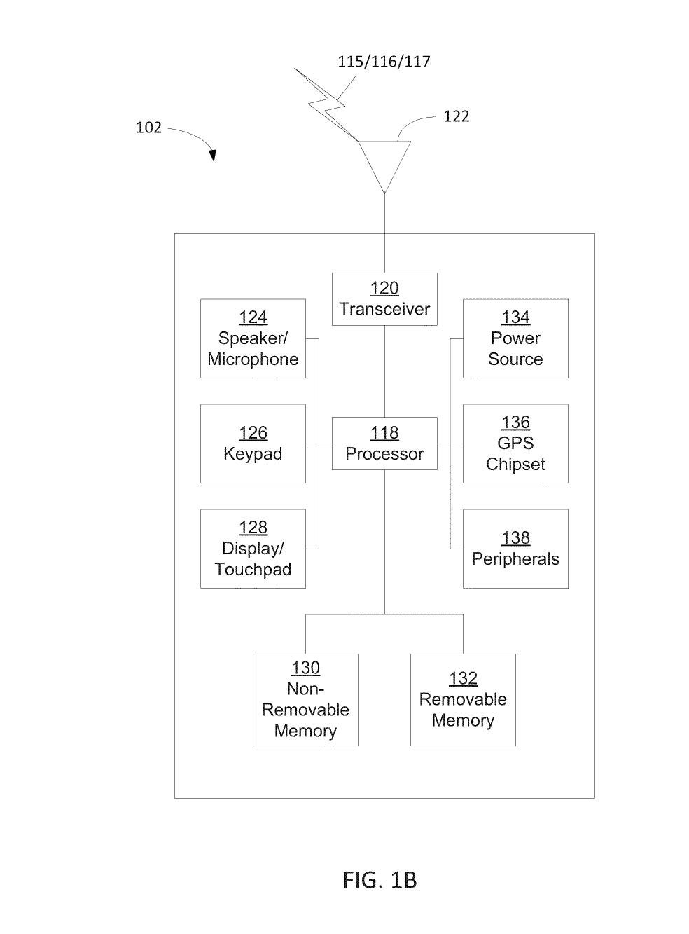

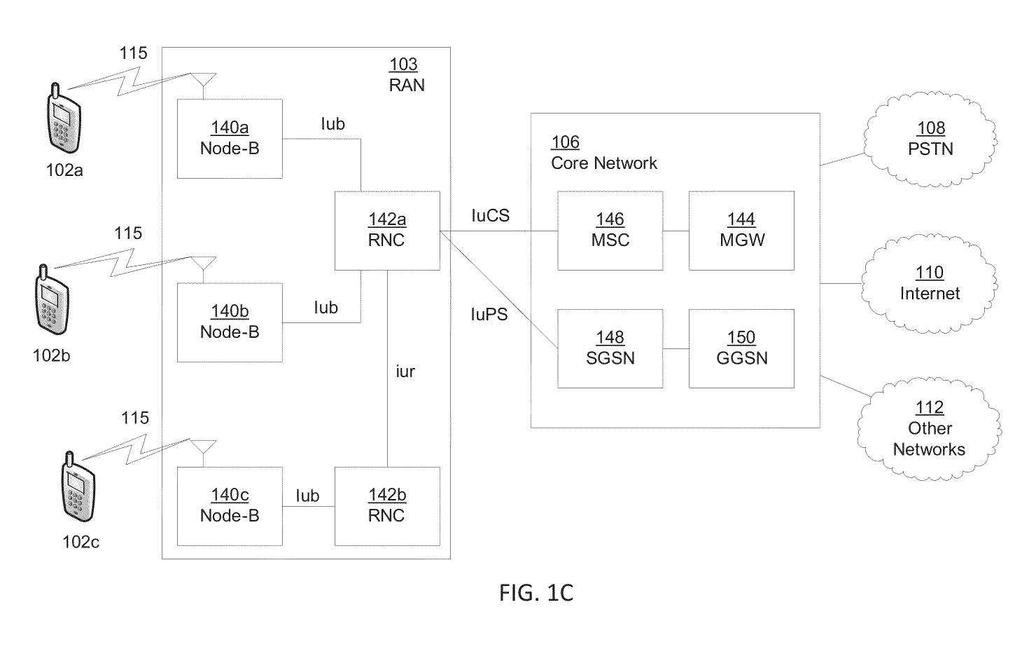

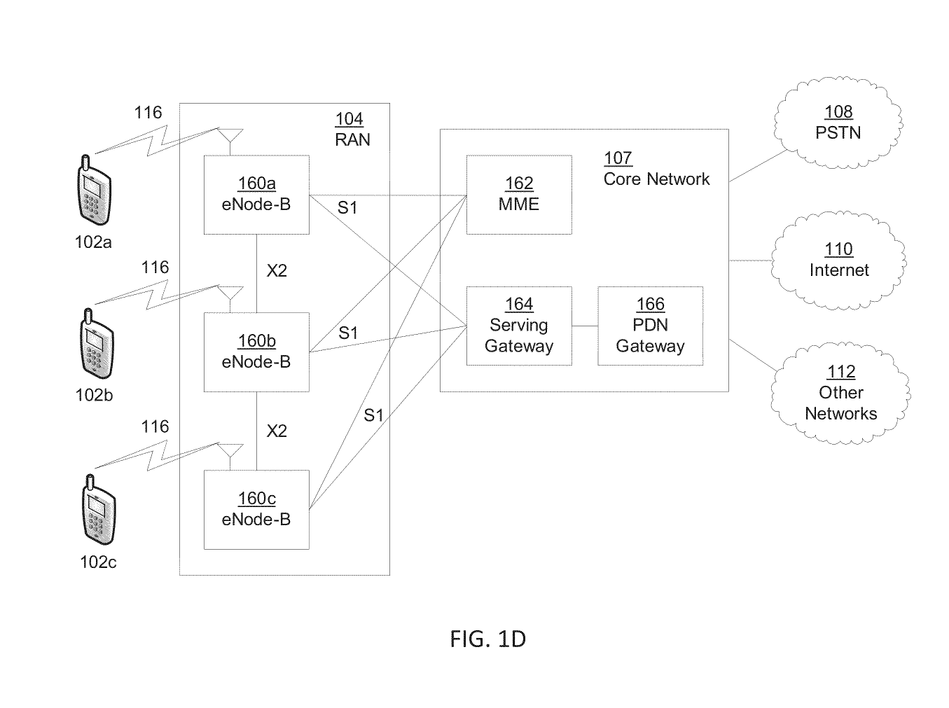

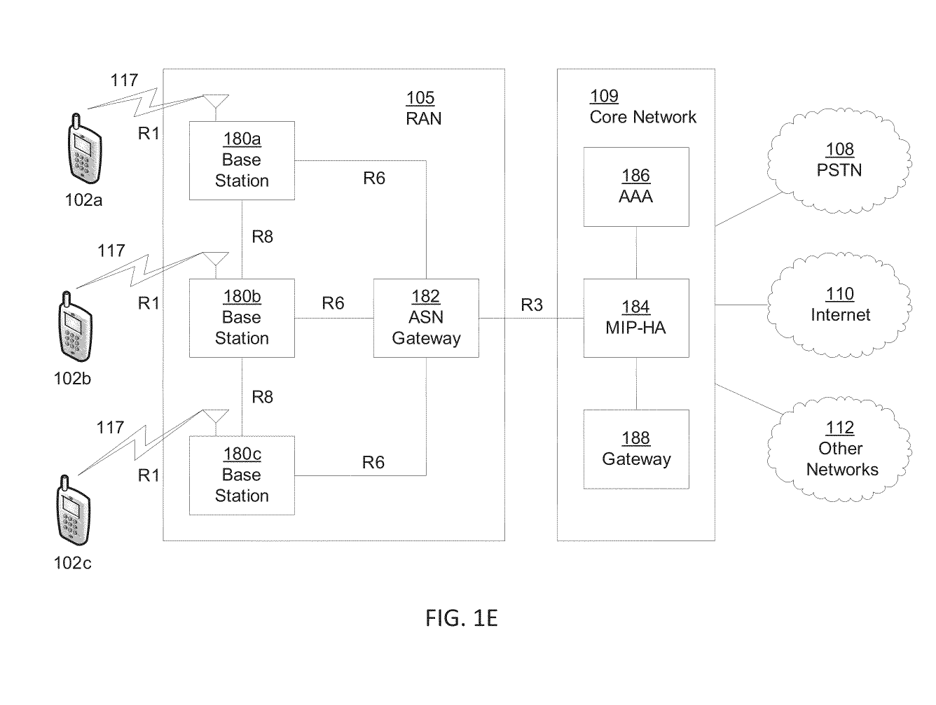

FIGS. 1A-1E are diagrams of example systems and/or apparatuses on which the embodiments described herein may be performed. FIG. 1A is a diagram of an example communication system 100 in which one or more disclosed embodiments may be implemented. The communication system 100 may be a multiple access system that provides content, such as voice, data, video, messaging, broadcast, etc., to multiple wireless users. The communication system 100 may enable multiple wireless users to access such content through the sharing of system resources, including wireless bandwidth. For example, the communication systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and/or the like.

As shown in FIG. 1A, the communication system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communication systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and/or the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, e.g., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communication system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and/or the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and/or the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communication networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communication system 100 may include multi-mode capabilities, e.g., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138. It will be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNode-B), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and/or the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, and/or receive signals from, a base station (e.g., the base station 114a) over the air interface 115/116/117. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and/or to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, and/or any other type of memory storage device. The removable memory 132 may include a subscriber identity module (SIM) card, a memory stick, a secure digital (SD) memory card, and/or the like. In other embodiments, the processor 118 may access information from, and/or store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and/or the like.

The processor 118 may be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and/or the like.

FIG. 1C is a system diagram of an example RAN 103 and core network 106. As described herein, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs.

As shown in FIG. 1C, the Node-Bs 140a, 140b may be in communication with the RNC 142a. Additionally, the Node-B 140c may be in communication with the RNC 142b. The Node Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and/or the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may be connected to the networks 112, which may include other wired or wireless networks that are owned and/or operated by other service providers.

FIG. 1D is a system diagram of an example RAN 104 and core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and/or the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and/or the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and/or the like. The ASN gateway 182 may serve as a traffic aggregation point and may be responsible for paging, caching of subscriber profiles, routing to the core network 109, and/or the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and/or a gateway 188. While each of the foregoing elements are depicted as part of the core network 109, it will be appreciated that any one of these elements may be owned and/or operated by an entity other than the core network operator.

The MIP-HA 184 may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and/or the core network 109 may be connected to other core networks. The communication link between the RAN 105 and the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

A wireless communication system may implement one or more nodes for performing wireless communications. A heterogeneous network (HetNet) may use macrocells and/or small cells (e.g., picocells and/or femtocells). The macro cell may overlap in service area with one or more small cells. While the examples provided herein may implement a picocell or a femtocell in an example small cell deployment, any other small cell deployment may be implemented. Small cell deployments may provide overall system capacity and/or cellular coverage gains. Deployment of picocells and/or femtocells of smaller coverage on the top of a macrocell based network may serve to reduce operating expense (OPEX) and/or capital expenditure (CAPEX). The nodes within a HetNet may have different characteristics, such as transmission power and/or coverage area. Communications within a service area may be performed in the spatial, time, and/or power domains.

The use of multiple cells within the same service area may have an impact on communications with a WTRU. Control channel communications and/or data channel communications may be impacted by the use of multiple cells within the same service area. The impact may be due to an imbalance between uplink and downlink transmissions.

A HetNet may be implemented in various types of networks, such as a High Speed Packet Access (HSPA) network for example. The HSPA air interface may be based on WCDMA technology, which may use multiple orthogonal channelization codes to facilitate multiple access for different users. The frequency reuse factor may be set to 1 in a co-channel deployment to make maximum use of the network capacity. The channelization code dimension for resource allocation may have a limited degree of freedom (e.g., 15 codes available), and/or may implement strict synchronization.

Uplink operation of HSPA (e.g., HSUPA) may be built on fast dynamic power control. Uplink functionalities, transport block size control, grant allocation, and/or network scheduling may be in terms of uplink transmit power. The communication network may be designed based on power contention.

The transmission timing of some physical channels may not be subframe aligned to others by design. For example, the HS-SCCH, which may be used to schedule downlink data, may be transmitted two slots ahead of the HS-DPSCH to support dynamic AMC and channelization code selection. Due to overlaid co-channel deployment of multiple cells of different sizes in the same coverage area, the interference in uplink and/or downlink may become complex for HSPA HetNet deployment.

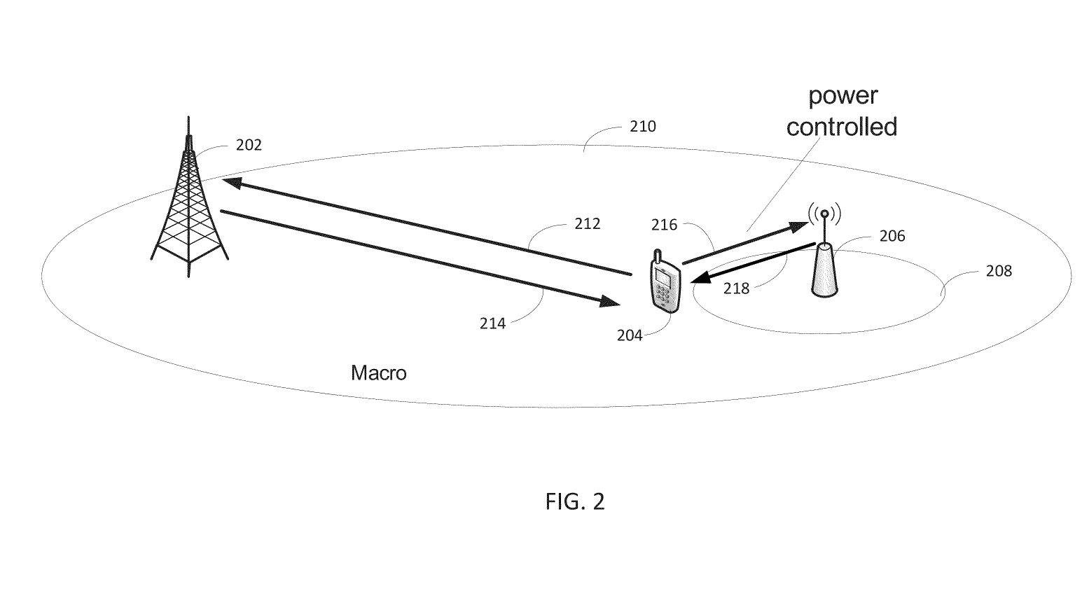

FIG. 2 is a diagram that depicts an example communication environment for performing communications using a HetNet. As shown in FIG. 2, a WTRU 204 may perform communications with a macrocell 202 when the WTRU 204 is at or within a service area 210. The WTRU 204 may perform communications with a picocell 206 when the WTRU 204 is at or within a service area 208. The picocell 206 may be implemented as a hot spot overlaid within the service area 210 provided by the macrocell 202. At or near the edge of the picocell 206 service area 208, the WTRU 204 may be served by the macrocell 202 and/or the picocell 206.

When the WTRU 204 is within the service area 208 of the picocell 206 and within the service area 210 of the macrocell 202, the WTRU 204 may be in communication with the macrocell 202 and the picocell 206. The WTRU 204 may perform communications with the macrocell 202 and the picocell 206 to perform a handover (e.g., a soft handover) from one cell to another. When the WTRU 204 is in communication with the macrocell 202 and the picocell 206, the WTRU 204 may receive data from the macrocell 202 and the picocell 206. The data may include power control instructions for controlling the power with which communications at the WTRU 204 may be performed.

Downlink communications may be performed between the macrocell 202 and the WTRU 204 via a downlink communication channel 214. In the downlink, the WTRU 204 may receive data reliably via the downlink communication channel 214 due to a proper transmit power at the macrocell 202. The downlink communication channel 214 may include a High-Speed Physical Downlink Shared Channel (HS-PDSCH) or other shared or dedicated downlink communication channel. The data transmitted on the downlink communication channel 214 may be received even though the pathloss towards the macrocell 202 may be higher than the pathloss towards the picocell 206.

Uplink communications may be performed between the macrocell 202 and the WTRU 204 via an uplink communication channel 212. The uplink communication channel 212 may be a control channel that may transmit power control information to the macrocell 202 for controlling the power with which the macrocell 202 transmits on the downlink communication channel 214. Power control information may include power control instructions that may recommend the network increase, decrease, or maintain a downlink transmission power, an indication of channel strength or quality on a downlink channel, an indication of receipt of information at the WTRU 204 (e.g., ACK or NACK), or the like. The uplink communication channel 212 may include an HS-DPCCH, a Dedicated Physical Control Channel (DPCCH), or other uplink control channel. Uplink communications may be performed between the picocell 206 and the WTRU 204 via uplink communication channel 216. The communication channel 216 may include an Enhanced-Dedicated Channel (E-DCH) or other uplink channel.

The WTRU 204 may combine the power control indications received from the network at 214 and 218. As the WTRU 204 approaches the picocell 206, the picocell 206 may instruct the WTRU 204 to lower the transmit power for communications on the uplink communication channel 216. The picocell 206 may request the reduction in the transmission power for the uplink communication channel 216 to reduce interference to other WTRUs that may be served by the picocell 206. The reduction in the transmit power on the uplink communication channel 216 may cause a reduction in the transmit power on the uplink communication channel 212. The power control request from the picocell 206 may override the power control request from the macrocell 202 due to the proximity of the WTRU 204 to each cell. While the information on the uplink communication channel 216 may be correctly received by the picocell 206 at the requested power level, the information on the uplink communication channel 212, which may support downlink transmission on the communication channel 214, may suffer from errors.

Errors may occur when pico deployment is densified and/or when cell range expansion (CRE) is not applied. A high error rate may exist where DF-DC/4C mode (e.g., multiple cell operation deployed over two carriers) is configured to achieve better aggregation gain, even with CRE engaged in one of the carriers.

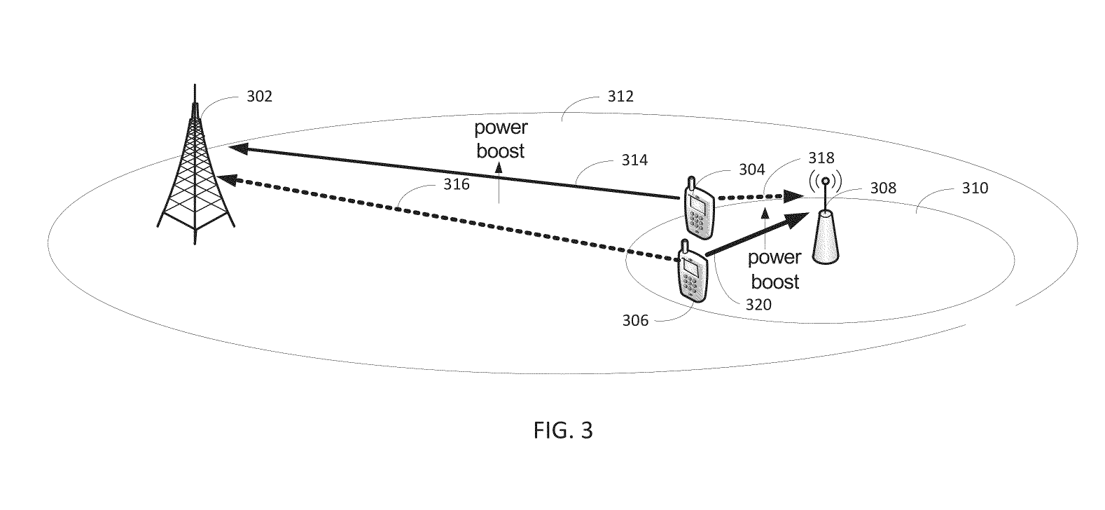

FIG. 3 is a diagram that depicts an example communication environment for performing communications using a HetNet. As shown in FIG. 3, a WTRU 304 and a WTRU 306 may each perform communications with a macrocell 302 when at or within a service area 312. The WTRU 304 and the WTRU 306 may each perform communications with a picocell 308 when at or within a service area 310. The picocell 308 may be closed subscriber group (CSG)-enabled and may communicate with WTRUs that are included in the CSG. The picocell 308 may be implemented in an area overlaid with the service area 312 of the macrocell 302. The WTRUs 304, 306 may gain access to the picocell 308 as they approach the picocell 308 service area 310.

The WTRU 304 may communicate with the macrocell 302 via the uplink communication channel 314. The WTRU 306 may communicate with the macrocell 302 via the uplink communication channel 316. The uplink communication channel 314 and/or the uplink communication channel 316 may include control information for controlling downlink communications from the macrocell 302. The uplink communication channel 314 and/or the uplink communication channel 316 may include an HS-DPCCH, a DPCCH, a Dedicated Physical Data Channel (DPDCH), an enhanced DPDCH (E-DPDCH), an enhanced DPCCH (E-DPCCH), or other uplink communication channel.

The WTRU 304 may communicate with the picocell 308 via uplink communication channel 318. The WTRU 306 may communicate with the picocell 308 via uplink communication channel 320. The uplink communication channel 318 and/or the uplink communication channel 320 may include control information for controlling downlink communications from the picocell 308. The uplink communication channel 318 and/or the uplink communication channel 320 may include an Enhanced-Dedicated Channel (E-DCH) (e.g., E-DPDCH and/or E-DPCCH) a DPDCH, a DPCCH, an HS-DPCCH, or other uplink shared or dedicated channel. The WTRU 304 may transmit control and/or data channels. The macrocell 302 and/or the picocell 308 may receive communications on one or more of these channels.

As the WTRU 304 and the WTRU 306 may each be communicating with the macrocell 302 and/or the picocell 308, the communications from the WTRU 304 and the WTRU 306 may interfere with one another. For example, the WTRU 304 and the WTRU 306 may each be performing a handover, such as a soft handover (SHO), from one cell to another. When a WTRU is in SHO it may be controlled simultaneously by the macrocell 302 and the picocell 308. A WTRU may be in SHO when the WTRU's active set is larger than 1, or when it is controlled by more than one cell. If each cell belongs to the same Node B, a SHO may be performed. When in SHO, the WTRU 306 may be serviced by the picocell 308, while the WTRU 304 may be serviced by the macrocell 302. The WTRU 304 may be attempting to communicate information to the macrocell 302 via uplink communication channel 314, while the WTRU 306 may be attempting to communicate information to the picocell 308 via communication channel 320, which may cause interference on either channel.

The WTRU 304 and/or the WTRU 306 may apply a power boost to one or more channels. The WTRU 304 may boost the transmission power on the uplink communication channel 314 to compensate for interference it may experience from other WTRUs, such as the WTRU 306 that may be communicating with the picocell 308. The power boost may be requested by the macrocell 302. The power boost may be performed upon detection of interference by the WTRU 304. The boost in transmission power for the uplink communication channel 314 may cause a boost in the transmission power for the communication channel 318. The channel to which the WTRU 304 may apply the power boosting may be the HS-DPCCH.

WTRU 306 may boost transmission power on the uplink communication channel 320 to compensate for interference it may experience from other WTRUs, such as the WTRU 304 that may be communicating with the macrocell 302. The WTRU 304 may receive a request for the power boost from the picocell 308. The power boost may be performed upon detection of interference by the WTRU 306. The boost in transmission power for the uplink communication channel 320 may also cause a boost in the uplink power for the uplink communication channel 316. The channel to which the WTRU 306 may apply the power boosting may be the HS-DPCCH.

A racing condition may be created as the WTRU 304 and the WTRU 306 increase their transmission power. The WTRU 304 and the WTRU 306 may raise their respective transmission power when the interference level changes as a result of the other WTRU increasing its transmit power resulting from the power control mechanism. As the WTRU 304 and the WTRU 306 may continue to increase their respective transmission power to overcome the noise created by the other WTRU's transmissions, each WTRU 304, 306 may exhaust their respective transmission power with little to no improvement on their uplink transmissions.

In the examples depicted in FIG. 2 and FIG. 3, the interference may be managed in LTE by appropriate frequency resource allocation. In HSPA, such frequency allocation may be unavailable. Network operators with single HSPA carriers may be unable to use inter-frequency handover to make use of different frequency allocation.

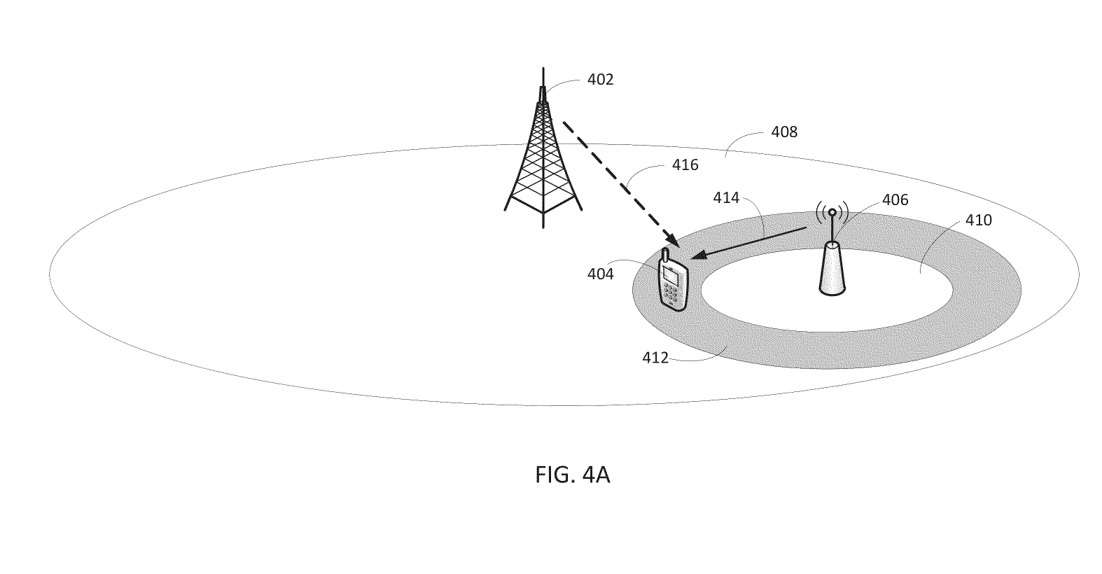

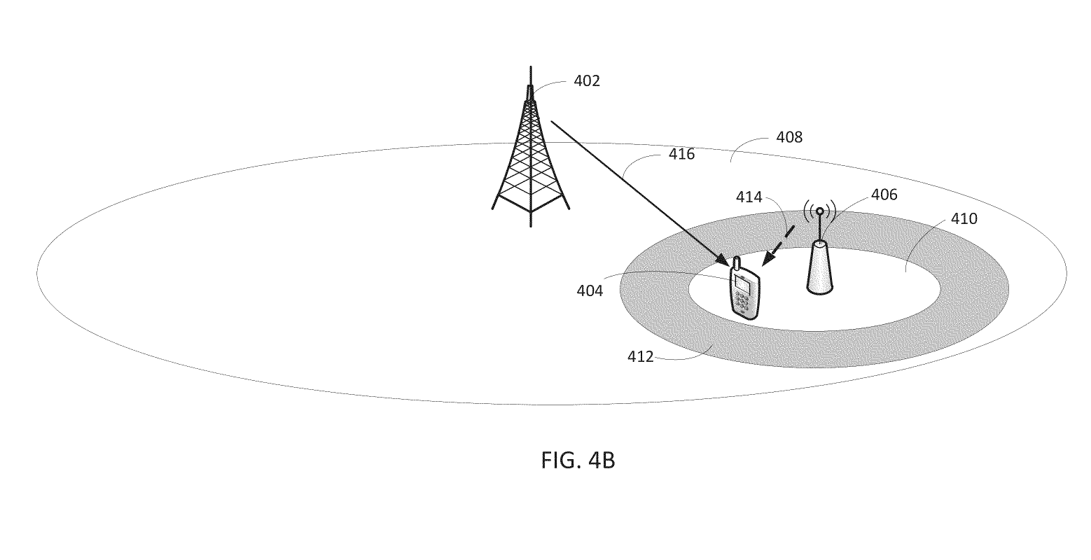

FIG. 4A is a diagram that depicts an example communication environment for performing communications using a HetNet. As shown in FIG. 4A, a WTRU 404 may perform communications with a macrocell 402 when at or within a service area 408. The WTRU 404 may receive information, such as control information or data, from the macrocell 402 via a downlink communication channel 416. The downlink communication channel 416 may include an HS-PDSCH, a High Speed Shared Control Channel (HS-SCCH), a Fractional Dedicated Physical Channel (F-DPCH) or DPDCH, an Enhanced Absolute Grant Channel (E-AGCH), an Enhanced HARQ Acknowledgement Indicator Channel (E-HICH), an Enhanced Relative Grant Channel (E-RGCH), or other downlink communication channel.

The WTRU 404 may perform communications with a picocell 406 when at or within a service area 410. The WTRU 404 may receive information from the picocell 406 via a downlink communication channel 414. The downlink communication channel 414 may include an HS-PDSCH, an HS-SCCH, an F-DPCH or DPDCH, an E-AGCH, an E-HICH, an E-RGCH, or other downlink communication channel. The picocell 406 may be closed subscriber group (CSG)-enabled and may communicate with WTRUs that are included in the CSG. The picocell 406 may be implemented in an area that may be overlaid with the service area 408 of the macrocell 402. The WTRU 404 may gain access to the picocell 406 as it approaches the service area 410.

Macro-pico interference may be caused in enhanced Inter-Cell Interference Coordination (eICIC) for downlink communications in HSPA HetNet deployments. The communications on the downlink communication channel 416 may cause interference with the communications on the downlink communication channel 414. The SNR may be greater as the WTRU 404 reaches the edge of the service area 410 or an extended picocell-edge 412. The service area 410 may be extended to include the picocell-edge 412 using CRE. Using CRE, the WTRU 404 may bias the measurements taken at a location such that the network configures the WTRU 404 to use the picocell 406 as the serving cell for communication, even though without CRE the WTRU 404 may use the macrocell 402 for communication based on the determined measurements.

As shown in FIG. 4B, the WTRU 404 may be within the service area 410 of the picocell 406. The WTRU 404 may attempt to receive data and/or control information via downlink communication channel 416. The information transmitted by the picocell 406 via the downlink communication channel 414 may cause interference with the information transmitted from the macrocell via downlink communication channel 416. The WTRU 404 may be attempting to receive data and/or control information from the macro cell 402 even though the WTRU 404 is within the service area 410 of the picocell 406. In an example, the picocell 406 may be CSG-enabled and the WTRU 404 may be not be CSG-enabled or may not be registered in the CSG of the pico-cell 406. While the WTRU 404 is shown as being outside of the extended picocell-edge 412, the same interference may be caused when the WTRU 404 is in the extended picocell-edge 412 as shown in FIG. 4A.

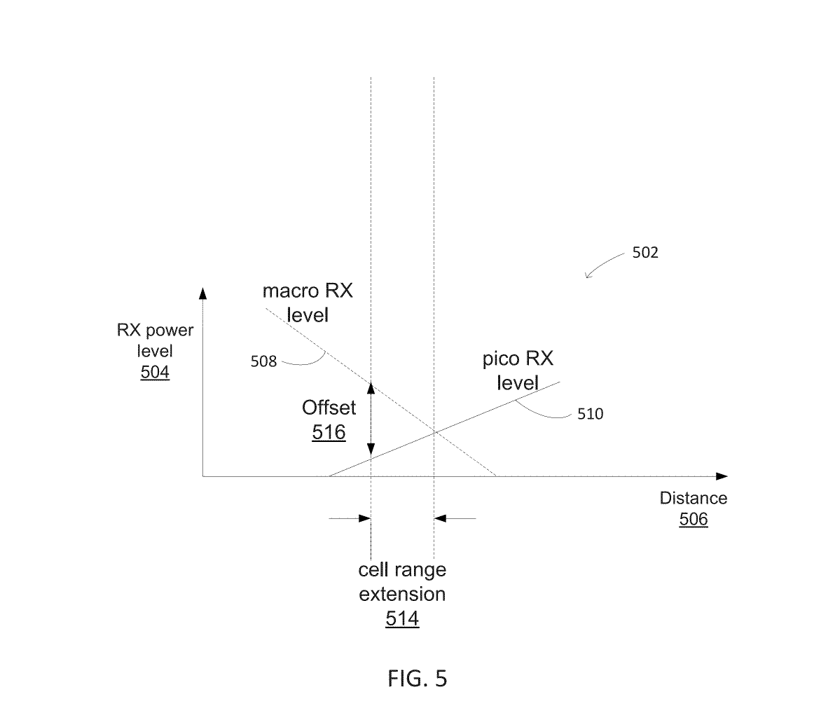

FIG. 5 is a graph 502 that illustrates an example of an offset 516 that may be used to implement CRE. For example, CRE may be implemented to extend the service area 410 of the picocell 406 to include the picocell-edge 412. The graph 502 shows a WTRU reception power level 504 on the y-axis and a WTRU distance 506 on the x-axis. The WTRU distance 506 may be the distance between a picocell, such as the picocell 406, and a macrocell, such as the macrocell 402. The WTRU distance 506 may begin at the macrocell 402 and may approach the picocell 406 as the distance 506 increases. The WTRU distance 506 may be expressed in terms of meters or in terms of pathloss in units of dB. The macrocell reception power level 508 may decrease as the WTRU 404 moves away from the macrocell 402. The picocell reception power level 510 may increase as the WTRU 404 moves toward the picocell 406.

The WTRU 404 may perform network communications via the macrocell 402 and/or the picocell 406 based on the macrocell reception power level 508 and/or the picocell reception power level 510. When the macrocell reception power level 508 is greater than the picocell reception power level 510, the WTRU 404 may perform network communications via the macrocell 402. When the picocell reception power level 510 is greater than the macrocell reception power level 508, the WTRU 404 may perform network communications via the picocell 406.

The cell range extension 514 may be equivalent to the distance of the picocell-edge 412. Though the WTRU 404 may be instructed to communicate with the macrocell 402 due to the value of the macrocell reception power level 508 being greater than the value of the picocell reception power level 510, the WTRU 404 may apply an offset 516 within the picocell-edge 412 to extend the distance at which the picocell 406 may be used for communication. The offset 516 may be used to compensate for the amount the macrocell reception power level 508 is above the picocell reception power level 510. The offset 516 may bias the WTRU 404 measurement toward the use of the picocell 406.

Referring again to FIG. 4A, when the WTRU 404 is at the picocell-edge 412, the WTRU 404 may receive network communications from the picocell 406 at a lower reception power level than from the macrocell 402. When the reception power level of the downlink communications from the macrocell 402 are higher than the reception power level of the downlink communications from the picocell 406, as may occur at the a picocell-edge 412, the downlink communication channel 416 from the macrocell 402 may interfere with the downlink communication channel 414 from the picocell 406. The downlink interference from the downlink communication channel 416 may be caused when the picocell 406 is deployed near the macrocell 402 or the center of the service area 408, such as when the picocell 406 is directed to data traffic offloading.

Network communications performed in a HetNet environment may be controlled, e.g., to mitigate interference. While features and/or elements may be described in the context of a HetNet, these features and/or elements may be implemented in other types of networks, such as homogeneous networks. One or more network entities may be used to compensate for poor control channel reception due to unequal Node B received power from multiple Node Bs and/or CRE. The uplink communication channel may include an HS-DPCCH, an E-DPCCH/E-DPDCH, a DPDCH, a DPCCH, an S-DPCCH, an S-E-DPDCH, an S-E-DPCCH when uplink closed loop transmit diversity (UL CLTD) or uplink multiple input multiple output (UL MIMO) is implemented, or other uplink communication channel. One or more control channels may be separately precoded from other uplink channels in beamforming. The set of precoding weights used by the control channel (e.g., HS-DPCCH) may be chosen towards the intended receiving Node B, while the other uplink channels (e.g., E-DPCCH/E-DPDCH and DPCCH), which may be power controlled, may use a different set of precoding weights. The set of precoding weights used by the other uplink channels may be tuned to the closest cell for SHO operation.

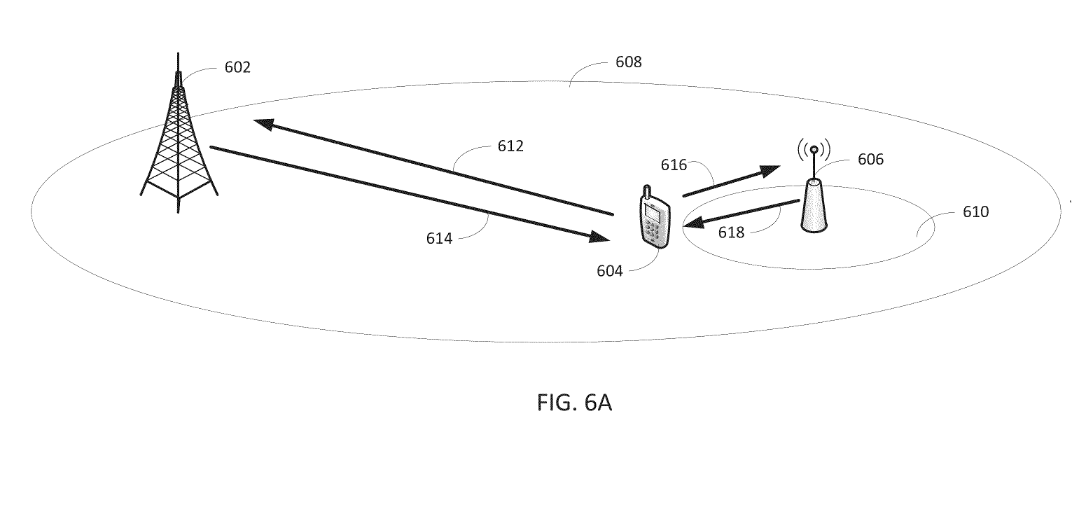

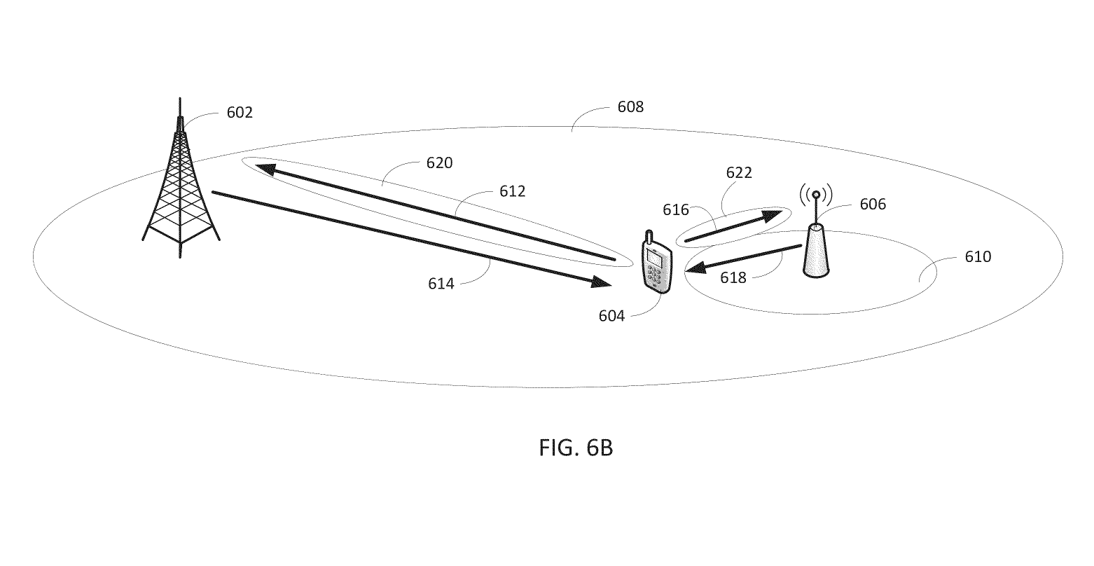

FIGS. 6A and 6B are diagrams that depict example communication environments for performing communications in a HetNet. The example communication environments in FIGS. 6A and 6B may be implemented to avoid interference. As shown in FIGS. 6A and 6B, a WTRU 604 may perform communications with a macrocell 602 when at or within a service area 608. The WTRU 604 may receive information, such as user requested data, from the macrocell 602 via a downlink communication channel 614. The WTRU 604 may receive information on the downlink communication channel 614 when the macrocell 602 is the serving cell. The downlink communication channel 614 may include an HS-DSCH, such as an HS-PDSCH, an HS-SCCH, an F-DPCH or DPDCH, an E-AGCH, an E-HICH, an E-RGCH, or other downlink communication channel. The WTRU 604 may communicate with the macrocell 602 via the uplink communication channel 612. The uplink communication channel 612 may include an HS-DPCCH or other control channel for communicating control information, such as acknowledgment information and/or channel quality information for the downlink communication channel 614.

The WTRU 604 may communicate with a picocell 606 when at or within a service area 610. The WTRU 604 may receive information, such as user requested data, from the picocell 606 via a downlink communication channel 618. The WTRU 604 may receive information on the downlink communication channel 618 when the picocell 606 is the serving cell. The downlink communication channel 618 may include an HS-DSCH, such as an HS-PDSCH, an HS-SCCH, an F-DPCH or DPDCH, an E-AGCH, an E-HICH, an E-RGCH, or other downlink communication channel. The WTRU 604 may send information to the picocell 606 via an uplink communication channel 616. The uplink communication channel 616 may include an HS-DPCCH, an E-DPCCH/E-DPDCH, a DPDCH, a DPCCH, an S-DPCCH, an S-E-DPDCH, an S-E-DPCCH when UL-CLTD or UL MIMO is implemented, or other uplink communication channel. The picocell 606 may be implemented in an area that may be overlaid with the service area 608 of the macrocell 602.

As shown in FIG. 6B, the uplink communication channels 612 and/or 616 may be control channels that may include control channel specific beamforming. The uplink communication channel 612 may include precoding weights 620 and/or the uplink communication channel 616 may include precoding weights 622, which may be represented as W_{UL}. Where the uplink communication channels 612, 616 include an HS-DPCCH, the precoding weights 620, 622 may be represented as W_{HS-DPCCH}. While HS-DPCCH is used as an example, the precoding weights 620, 622 may be used for other control channels.

To support control channel beamforming, the WTRU 604 may transmit a sounding signal or pilot in the uplink communication channel 612 and/or the uplink communication channel 616. The sounding signal or pilot may be transmitted on the uplink communication channel 612 when the macrocell 602 is the serving cell. The sound or pilot may be transmitted on the uplink communication channel 616 when the picocell 606 is the serving cell. The sounding signal or pilot may be periodic or aperiodic. The sounding signal or pilot may be transmitted periodically or continuously. The sounding signal or pilot may have a fixed transmit power or a transmission power which may be periodically lowered.

The communications on the uplink communication channel 612 and the communications on the uplink communication channel 616 may use different respective precoding weights 620 and 622, e.g., to avoid interference. The macrocell 602 may calculate a set of the precoding weights 620 based on the sounding signal or pilot received from the WTRU 604, such as when the macrocell 602 is the serving cell. The picocell 606 may calculate another set of precoding weights 622 based on the sounding signal or pilot received from the WTRU 604, such as when the picocell 606 is the non-serving cell. The set of precoding weights 620 and/or the set of precoding weights 622 may be signaled to the WTRU 604 via L1 or higher layer signaling. The precoding weights 620 may be signaled to the WTRU 604 on the downlink communication channel 614 from the macrocell 602. The precoding weights 622 may be signaled to the WTRU 604 on the downlink communication channel 618 from the picocell 606. The WTRU 604 may use the set of precoding weights 620 for sending control information on the uplink communication channel 612. The WTRU 604 may use the set of precoding weights 622 for sending information on the uplink communication channel 616. The picocell 606 may choose not to precode the communications on the uplink communication channel 616, e.g., to optimize the SHO reception. In this case, the precoding weights 622 may not be applied to the uplink communication channel 616.

The WTRU 604 may dynamically control the uplink communication channel transmission power by dynamically boosting the transmission power. The dynamic power control may be performed with or separate from the precoding. The uplink communication channel transmission power may be individually power controlled. The individual power control on the uplink communication channel may increase control channel reception at the intended receiving cell. The power control may be implemented dynamically to change according to channel changes for the WTRU 604. For example, the transmission power on the uplink communication channel 616 may be increased when the transmission power on the uplink communication channel 612 is increased. The macrocell 602 may send the dynamic power control instructions to the WTRU 604 on the downlink communication channel 614. The dynamic power control instructions may be based on measurements taken by the WTRU 604. The picocell 602 may send similar dynamic power control instructions on the downlink communication channel 618 when the picocell 602 is the serving cell.

The WTRU 604 may autonomously control the power of the uplink communication channel transmissions. The WTRU 604 may take measurements of network conditions, which may be used for controlling the power of transmissions in the uplink. The WTRU 604 may take measurements separately for communications with the serving cell (e.g., the macrocell 602) and the non-serving cell (e.g., picocell 606). The WTRU 604 measurements may include the pathloss, received signal code power (RSCP), received signal strength indication (RSSI), common pilot channel (CPICH) chip-level signal-to-noise ratio (Ec/No), CPICH chip-level signal-to-interference ratio (Ec/Io), and/or other quantities that may indicate signal quality. The WTRU 604 may determine a difference (e.g., by comparison) between the measurements of the representative cells. The WTRU 604 may autonomously determine an amount of power boost for communications on the uplink communication channel for the serving cell (e.g., based on the difference). For example, when the macrocell 602 is the serving cell, the WTRU 604 may determine the transmission power of the uplink communication channel 616 and decide to increase the transmission power of the uplink communication channel 612 when the uplink communication channel 616 is increased. The WTRU 604 may decide to decrease the transmission power of the uplink communication channel 612 when the transmission power of the uplink communication channel 616 is decreased.

The measurements taken by the WTRU 604 may be used to mitigate interference. The measurement may be taken with appropriate changes in thresholds, conditions, offset parameters, and/or the like. For example, the WTRU 604 may measure the Ec/Io and/or Ec/No of the downlink communication channel 614 for the macrocell 602 and/or the downlink communication channel 618 for the picocell 606. The WTRU 604 may determine a gain to apply to a configured control channel gain factor based on the difference between the two measurements and/or an additional offset configured by the network. The gain may be determined in addition to the gain signaled to the WTRU 604 by the network. The WTRU 604 may measure the Ec/No of the downlink communication channel from the serving cell (DL_{S}), which may be the macrocell 602, and the Ec/No of the downlink communication channel from the non-serving cell (DL_{NS}), which may be the picocell 606. The WTRU 604 may determine the difference between the DL_{S} and the DL_{NS}. The difference may be determined using Equation (1) as follows:

DL_{Δ}=DL_{NS}−DL_{S}+Offset Equation (1)

The DL communication channel may be a CPICH. The values of Equation (1) may be measured in dB. The offset may be signaled by the network via higher layers. The offset may be used by the network to compensate for differences in Node-B transmit power between the serving cell and the non-serving cell, which may create an imbalance.

The WTRU 604 may be configured to increase the uplink communication channel gain factor based on the Ec/No difference DL_{Δ} directly. For example, the WTRU 604 may apply a correction to the gain factor using Equation (2) as follows:

$$\frac{{β}_{CC}^{′}}{{β}_{c}} = \frac{{β}_{CC}}{{β}_{c}} {10}^{{DL}_{Δ} / 10} \qquad Equation ( 2 )$$

β′_{CC} may be the compensated control channel gain factor, β_{c} may be the gain factor for the control channel. The WTRU 604 may apply this compensation when the DL_{Δ} is positive. The gain factor may be calculated to ensure that the gain factor may be larger than the configured gain factor. For example, the following Equation (3) may be implemented:

β′_{CC}=β_{CC}·max(1,10^{DL}^{_{Δ}}^{/10}) Equation (3)

The WTRU 604 may increase the control channel gain factor as a function of the Ec/No difference. For example, the WTRU 604 may be configured to determine the difference between the DL channels, as illustrated in Equation (1). The offset may be configured by the network. The WTRU 604 may determine a compensation factor based on the DL_{Δ} using a configured lookup table. An example lookup table is illustrated in TABLE 1.

TABLE 1
Example Control Channel Compensation Factor Based on DL_{Δ}

| Compensation (Δ_{CC}) | DL_{Δ} |
|---|---|
| 0 dB | DL_{Δ} ≦ 0 dB |
| 1 dB | 0 dB < DL_{Δ} ≦ 3 dB |
| 2 dB | 3 dB < DL_{Δ} ≦ 6 dB |
| . . . | . . . |
| 6 dB | DL_{Δ} > 10 dB |

The WTRU 604 may apply the compensation using Equation (4) as follows:

β′_{CC}=β_{CC}·10^{Δ}^{_{CC}}^{/10}. Equation (4)

A linear-scale compensation factor may be similarly implemented. For example, a linear-scale compensation factor may be implemented as shown in Equation (5) as follows:

β′_{CC}=β_{CC}·Δ_{CC} Equation (5)

, where Δ_{CC} is expressed in linear units.

The WTRU 604 may include a threshold parameter and an associated compensation factor. When the DL_{Δ} becomes larger than the threshold, the associated compensation factor may be applied to the control channel. After the compensation factor is applied to the control channel gain factor, the WTRU 604 may quantize the value of the control channel gain factor using the values from a quantization table.

The WTRU 604 may calculate and/or apply the compensation factor on a control channel subframe basis or over a longer period, such as over a period of multiple control channel subframes. The WTRU 604 may measure the Ec/Io difference over a larger observation period (e.g., 100 ms-200 ms) than a 2 ms subframe. The resulting compensation factor may be applied by the WTRU 604 over the larger observation period. The WTRU 604 may measure the Echo difference using windowing. The WTRU 604 may use a moving average filter.

The network may direct control channel power control. Based on the measurements taken by the WTRU 604, a measurement event may be introduced that may be triggered if the difference of the measurements (e.g., DL_{Δ}) from the macrocell 602 and the picocell 606 exceeds a threshold or falls into a range. The WTRU 604 may report the amount of difference in the measurement event. The amount of difference may be used by the network to assist the network's decision. Upon receiving the event message from the WTRU 604, the network may choose to direct the WTRU 604 to boost or reduce the control channel transmission power. The network may direct the WTRU 604 via L1 (e.g., via HS-SCCH order) and/or higher layer signaling (e.g., RRC signaling). The WTRU 604 may be configured with a single power boost value that the WTRU 604 may apply on the control channel (e.g., the HS-DPCCH) upon reception of an activation indication (e.g., over L1 using HS-SCCH order). The WTRU 604 may deactivate the power boost upon reception of a deactivation indication (e.g., over L1 signaling using an HS-SCCH order).

Subframes of the control channel may be bundled to avoid interference. The control channel may be enhanced by repeatedly sending the same feedback information across multiple subframes. At the macrocell 602 receiver, these subframes of control channel data may be bundled or combined to enhance the signal quality. Subframes may be similarly bundled or combined at the picocell 606 receiver or other Node-B.

To enable control channel bundling for ACK/NACK, downlink scheduling from the macrocell 602, or other serving cell, may be restricted. The downlink scheduling may be restricted to prevent the repeated ACK/NACK messages from colliding. A repetition factor may be used for control channel transmissions to indicate a number of repetitions and may be used to block subframes of data from being scheduled to the WTRU 604. If a repetition factor for control channel transmission is set (e.g., to 2), each of the other subframes may be blocked for data scheduling to the same WTRU. This may allow sufficient space for the control channel repetition.

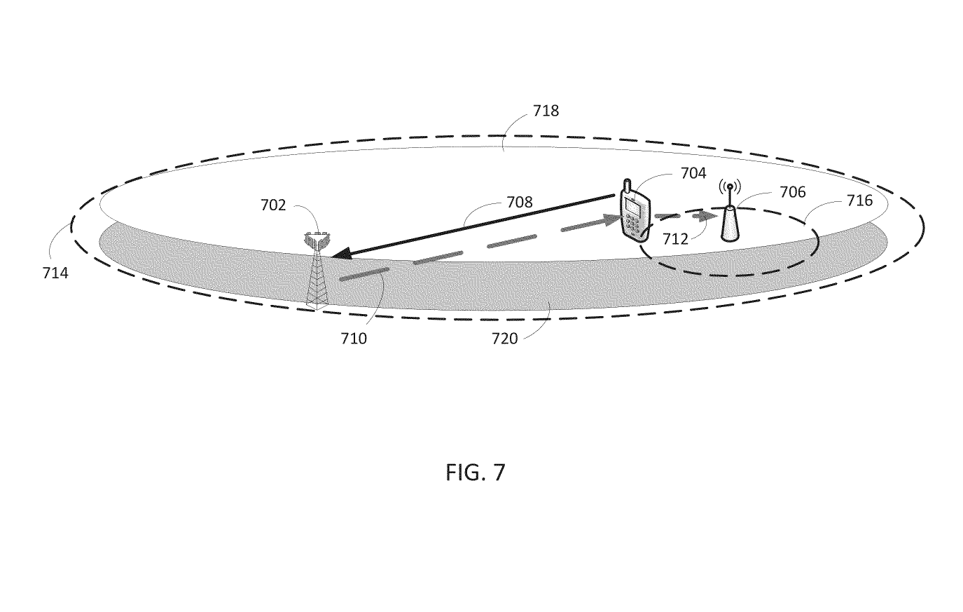

FIG. 7 is a diagram that depicts an example communication environment for implementing a cross-carrier control channel. As shown in FIG. 7, a WTRU 704 may perform communications with a macrocell 702 and/or a picocell 706 in a dual carrier environment. The picocell 706 may be deployed as a hot spot in a dual carrier macro environment. The WTRU 704 may communicate with the macrocell 702 on a carrier 718 and/or a carrier 720 when at or within a service area 714. The carrier 718 and the carrier 720 may be transmitted at different frequencies. The WTRU 704 may receive information, such as user requested data, from the macrocell 702 via a downlink communication channel 710. The downlink communication channel 710 may include an HS-PDSCH, an HS-SCCH, an F-DPCH or DPDCH, an E-AGCH, an E-HICH, an E-RGCH, or other downlink communication channel. The WTRU 704 may communicate with the macrocell 702 via the uplink communication channel 708. The uplink communication channel 708 may include an HS-DPCCH or other control channel for communicating control information, such as acknowledgment information (e.g., Ack/Nack) and/or channel quality information (e.g., CQI) for the downlink communication channel 710.

The WTRU 704 may perform communications with a picocell 706 on the carrier 718 and/or the carrier 720 when at or within a service area 716. The WTRU 704 may send information to the picocell 706 via an uplink communication channel 712. The uplink communication channel 712 may include an HS-DPCCH, an E-DPCCH/E-DPDCH, a DPDCH, a DPCCH, an S-DPCCH, an S-E-DPDCH, an S-E-DPCCH when UL-CLTD or UL MIMO is configured, or other uplink communication channel. The picocell 706 may be implemented in an area that may be overlaid with the service area 714 of the macrocell 702.

The uplink communication channel 708 on which the WTRU 704 may communicate with the macrocell 702 may be transmitted on a separate carrier frequency from the uplink communication channel 712 on which the WTRU 704 may communicate with the picocell 706 to avoid interference between uplink communication channels. The uplink communication channel 708 may be transmitted on the carrier 718, while the uplink communication channel 712 may be transmitted on the carrier 720. Information may be transmitted on the uplink communication channel 708 via carrier 718 with less interference than when transmitted on the carrier 720.

Referring again to FIG. 6A, an example may be illustrated for implementing transmit power control (TPC) commands in a communication environment for HetNet. The picocell 606 may send a power-down TPC command to the WTRU 604 on the downlink communication channel 618 to instruct the WTRU 604 to decrease transmission power on the uplink communication channel 612 to the macrocell 602. The power-down TPC command may be sent to the WTRU 604 when the WTRU 604 uses higher transmission power to maintain the uplink communication channel 612 with the macrocell 602.

The picocell 606 may disregard and/or prevent transmission of a power-down TPC command in some time slots to create a virtual blank period. The virtual blank period may be created to protect the transmissions from the WTRU 604 on the uplink communication channel 612 (e.g., HS-DPCCH) to the macrocell 602. The picocell 606 may transmit a power-up command to the WTRU 604 on the downlink communication channel 618. When the WTRU 604 is expecting a hold command and/or a power-down command, the transmission of the power-up command may result in the WTRU 604 ignoring the power-up command. In the period in which the WTU 604 ignores the power-up command, the transmission power of the WTRU 604 on the uplink communication channel 612 toward the macrocell 602 may be boosted, e.g., to the value instructed by the macrocell 602 when the WTRU 604 is not instructed to power down the uplink communications from the picocell 606. When the transmission power of the WTRU 604 on the uplink communication channel 612 is boosted, the reliability of the communications on the uplink communication channel 612 (e.g., control information on the HS-DPCCH) may be increased and/or guaranteed.

The WTRU 604 may be configured to ignore the TPC commands received from a problematic cell. The problematic cell may be the picocell 606 or the macrocell 602 from which the TPC commands may be received. The WTRU 604 may determine that the picocell 606 is problematic. When the picocell 606 is determined to be problematic, such as when one or more problematic conditions are detected, the WTRU 604 may assume the TPC command is “1” or a power-up command regardless of its actual value (e.g., “1” or “0”). The problematic conditions may be detected when the measured DL_{Δ} meets a set of one or more configurable conditions, such as when the DL_{Δ} is above/below a problematic threshold, the DL_{Δ} is within a problematic range, and/or the like.

When the WTRU 604 determines that there is a problematic situation, such as when one or more problematic conditions are met, the WTRU 604 may obey the TPC command received from the picocell 606. For example, the WTRU 604 may reduce the transmission power for the uplink communication channel 612 as instructed. The power-down command received from the picocell 606 on the downlink communication channel 618 may act as an implicit indication to adjust the gain factor for the uplink communication channel 612 (e.g., the HS-DPCCH gain factor). When a down command for the uplink communication channel 612 is detected from the problematic picocell 606, the WTRU 604 may determine that the gain factor for the uplink communication channel 612 may be adjusted.

The gain factor for the uplink communication channel 612 may be adjusted dynamically according to the received TPC commands. The WTRU 604 may be configured with default gain factors to use. The WRU 604 may be configured with a set of one or more adjustment factors. The gain factors may be a set of absolute gain values that the WTRU 604 may use for transmission of the uplink communication channel 612 (e.g., absolute adjustment). The adjustment factors may be added on top of the gain factor as compensation. The gain factors may be changed directly to adjust the fixed gain factor value (e.g., relative adjustment). The gain factors and/or adjustment factors may be in a form of a table. An index may be associated with each entry of the table. The WTRU 604 may have a default gain factor for the uplink communication channel 612, a step adjustment factor, and/or a maximum value that may be used.

The WTRU 604 may use the default gain factor for the uplink communication channel 612, determine to increase the index pointing to an entry in the table by 1 or by another value, and/or determine the value of the uplink communication channel 612 by incrementing the gain factor used by a configured step factor up to a maximum value. For example, the WTRU 604 may use the default gain factor and/or increment the index in the table as, described herein, when one or more of the following are met: the WTRU 604 determines that a problematic scenario exists (e.g., the DL_{Δ} is above/below a problematic threshold, the DL_{Δ} is within a problematic range, etc.); a power-down command is received from the problematic picocell 606; a power-up command is received from the serving cell, such as the macrocell 602, or from the serving radio link (RL) set in the same slot or TPC combining window; the network sends a control channel (e.g., HS-SCCH) order indicating to the WTRU 604 to begin adjusting the gain factor of the uplink communication channel 612 (e.g., HS-DPCCH gain factors); a control channel (e.g., HS-SCCH) order is received indicating to the WTRU 604 to increase the power, with or without the gain factor included in the command and/or a step factor included in the control channel (e.g., HS-SCCH) order; the network configures the WTRU 604 to begin dynamically adjusting the gain factors of the uplink communication channel 612 (e.g., HS-DPCCH gain factors) accordingly; and/or the maximum gain factor value of the uplink communication channel 612 (e.g., HS-DPCCH gain factor value) has not been reached. The maximum gain factor value may be reached when the current index value equals the maximum index value and/or the current gain factor of the uplink communication channel 612 (e.g., HS-DPCCH gain factor value) is the largest value in the configured gain factor table.

The WTRU 604 may be configured to decrease the HS-DPCCH gain factor by the configured step factor and/or decrease the HS-DPCCH gain factor to a default value when one or more of the following conditions are met: the picocell 606 is no longer problematic; the WTRU 604 detects the serving cell (e.g., macrocell 602) and/or the serving radio link set sends a power-up command and no power-down command is received from the problematic cell; an explicit HS-SCCH order and/or RRC message is received to indicate that the WTRU 604 may no longer dynamically adjust the HS-DPCCH power; and/or an explicit HS-SCCH order is received indicating an HS-DPCCH gain factor down command, with or without the step factor and/or gain factor included in the command. When the picocell 606 is no longer problematic, the WTRU 604 may fall back to using the default value.

Interference coordination may be performed using time domain resource partitioning. Interference may be mitigated using interference coordination strategies via time domain resource partitioning for downlink and uplink transmissions.

Downlink interference coordination may be performed, as described herein. Cross-cell downlink interference, as illustrated in FIGS. 4A and 4B, may be mitigated when use of the time domain resources is coordinated among the transmitting cells. An aggressor cell may be a cell that is creating interference. A victim cell may be a cell affected by the interference. The aggressor cell may be instructed to blank out some pre-defined subframes. The pre-defined subframes may be blanked out to create protected periods that may be used by a victim cell for interference-free transmission.

The blank operation may have different levels of interpretation depending on an intended design. Downlink transmission may be stopped using a blank period. During the blank period, data channels (e.g., HS-DSCH) may not be scheduled. To support network operation, some of the control channels may be allowed to transmit in the blank period. Transmission of some control channels designed for WTRU measurement and synchronization (e.g. P-CCPCH and CPICH) may be performed. During the blank period, the data channels may be scheduled with lower power. Other controlled channels may be transmitted with different powers.

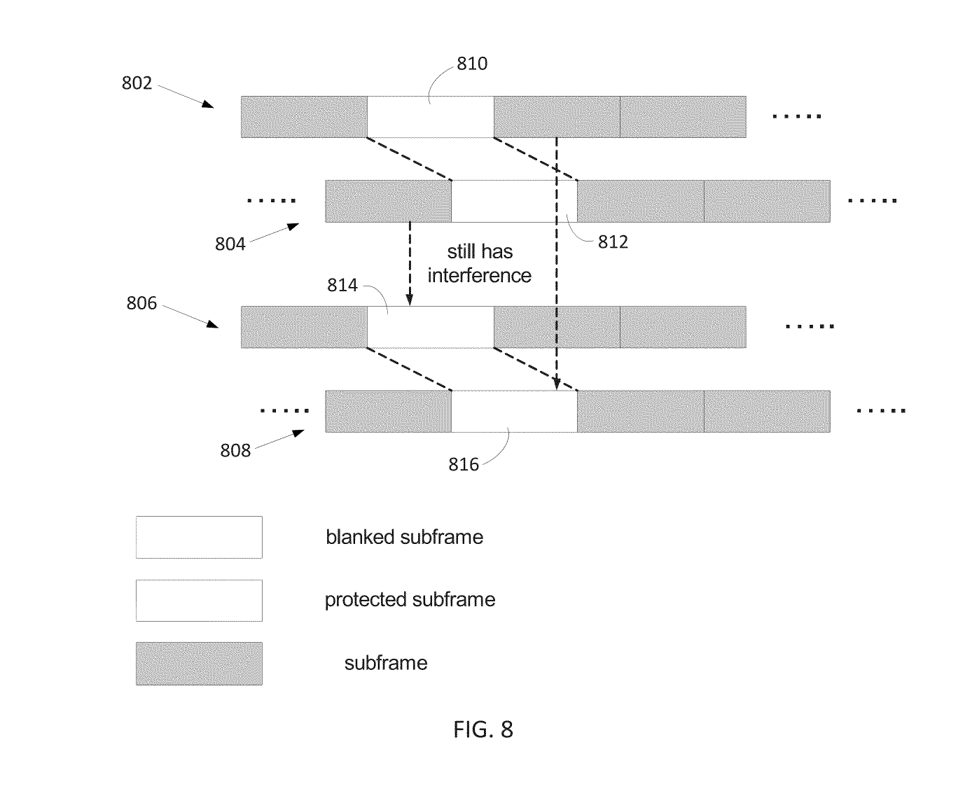

When blanking is applied, challenges may arise where the blanking periods are not aligned for transmissions. FIG. 8 is a diagram depicting an example of an unaligned subframe structure for downlink transmissions. As shown in FIG. 8, aggressor cell communications 802, 804 may be transmitted from an aggressor cell. The aggressor cell may be may be causing interference with its transmissions. Victim cell communication 806, 808 may be transmitted from a victim cell. The communications 802, 806 may be control channel communications, such as an HS-SCCH communications. The communications 804, 808 may be data channel communications, such as HS-PDSCH communications.

The communications 802, 804, 806, 808 may each include a number of subframes. The aggressor cell communications 802, 804 may include blanked subframes 810, 812. The victim cell communications 806, 808 may include protected subframes 814, 816, which may be aligned with the blanked subframes 810, 812, respectively, to mitigate the interference caused by the aggressor cell communications 802, 804. The protected subframe 814 in the victim cell communication 806 may be aligned with the blank subframe 810 in the aggressor cell communication 802. The protected subframe 816 in the victim cell communication 816 may be aligned with the blank subframe 812 in the aggressor cell communication 804.

The aggressor cell communications 802, 804 may still cause interference with the protected subframes 814, 816 in the victim cell communications 806, 808. As shown in FIG. 8, the aggressor cell communication 804 may cause interference with the protected subframe 814 and/or the aggressor cell communication 802 may cause interference with the protected subframe 816. This may be because the protected subframe 814 may be unaligned with the blank subframe 812 and/or the protected subframe 816 may be unaligned with the blank subframe 810. The protected subframe 814 may receive interference at its head from the aggressor cell communication 804. The protected subframe 816 may receive interference at its tail from the aggressor cell communication 802.

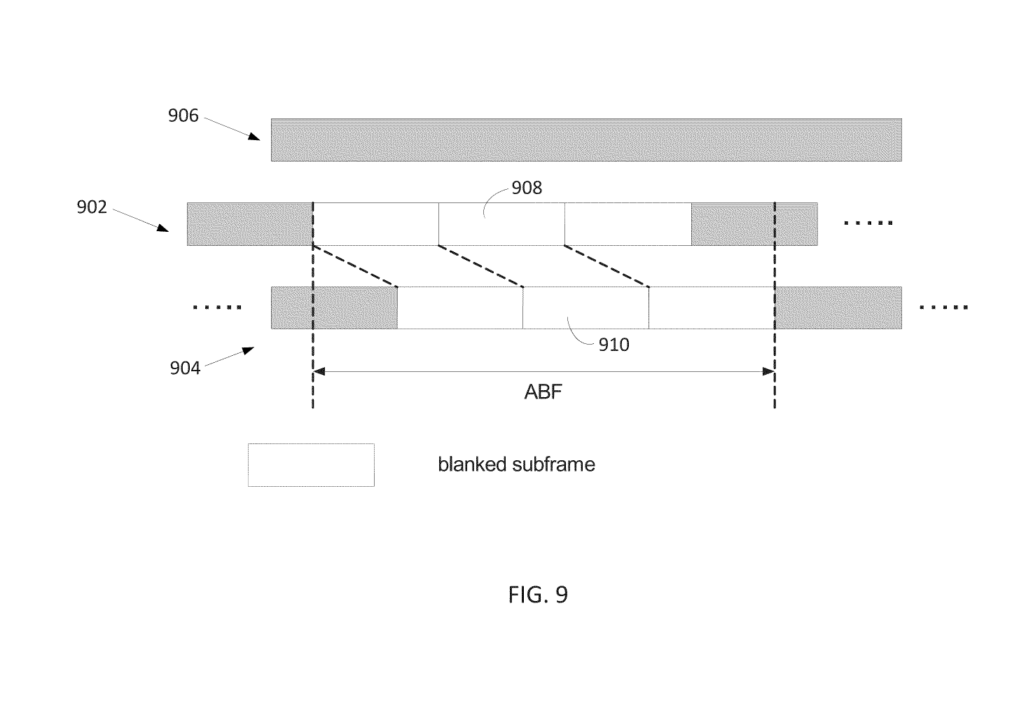

FIG. 9 is a diagram depicting an example of an almost blank frame (ABF) structure for transmissions from an aggressor cell. As shown in FIG. 9, an aggressor cell communication 902 and an aggressor cell communication 904 may include a blanking period 908 and a blanking period 910, respectively, that may each include multiple blank subframes. The aggressor cell communication 902 may be a control channel (e.g., HS-SCCH) communication. The aggressor cell communication may be a data channel (e.g., HS-PDSCH) communication. The blanking periods 908, 910 for the aggressor cell communications 902, 904 may be defined for a longer period than a single subframe to mitigate or avoid interference due to non-alignment. The basic unit of the blanking periods 908, 910 in interference coordination may be a blank frame, which may include a number of consecutive blank subframes. Since other physical channels 906, such as CPICH or P-CCPCH, may be used to transmit to support network operation, the blanking periods 908, 910 may be referred to as an ABF. The ABF may stretch from the beginning of a first subframe of a control channel communication to the end of a last subframe of a data channel communication.

A victim cell may have a protected frame period (not shown) that may correspond to the blanking period 908 and/or the blanking period 910 of the aggressor cell. The victim cell may suffer from interference in a protected subframe in the protected frame period due to non-alignment with the blanking period 908, 910 of the ABF. For example, data transmitted in a head subframe or a tail subframe of the protected frame period may overlap with aggressor cell communications 902 or 904 outside of the blanking period 908, 910 of an ABF. The middle subframe(s) and/or one of the ends of the protected subframes of the victim cell may be aligned with the blanking period 908, 910 of the ABF.

The interference caused by overlap may be mitigated or avoided by using a portion of the protected frame period as a guard interval. The head and/or tail subframes, or a portion thereof, of the protected frame period may be considered as a guard interval. No data may be scheduled from the aggressor cell and/or the victim cell during the guard interval.

During transmission of a subframe, such as the head subframe, of the protected frame period, the transmission from the victim cell may be boosted in power to mitigate interference from an aggressor cell communication 902, 904. The amount of boost may be preconfigured or determined by the network based on WTRU measurements made from the radio link towards both cells. The amount of boost used may be signaled to the WTRU and/or to other neighboring cells. The WTRU may request a higher TX power on a control channel (e.g., HS-SCCH) subframe.

During transmission of a subframe, such as the tail subframe, of the protected frame period, the victim cell may schedule data even with interference from an aggressor cell communication 902, 904. The transport block size (TBS) in a subframe may be reduced to avoid the interference. The WTRU may report the CQI for the tail subframe. The WTRU may report an incremental CQI in a slow rate via higher level signaling. During the transmission of the head subframe of the protected frame period, the aggressor may be allowed to schedule data with lowered transmit power. The amount of TX power reduction may be preconfigured or determined based on the reported WTRU measurements.

The ABF patterns used at each cell may be signaled via Iur/Iub interfaces to its neighboring cells for coordination. The WTRUs in the serving area may be notified of the information via RRC so that the WTRU may perform a corresponding resource specific measurement.

The communication timing may be modified to align data channel (e.g., HS-PDSCH) subframes with control channel (e.g., HS-SCCH) subframes. For the data channel subframe, which may last 2 ms, guard periods may not be used. The interference may be managed with blanking subframes. The data channel/control channel timing may be available for implementation by some WTRUs, such as non-legacy WTRUs, and may not be implemented by other WTRUs, such as legacy WTRUs.

A synchronization procedure may be implemented to support data channel interference coordination. Application of time domain resource partitioning may use synchronization of the data channel transmissions of the aggressor and victim cells. The subframe boundaries of the data channel communications transmitted from the two cells may be aligned.

A synchronization procedure may be used to align the DPCH or F-DPCH frames of two cells in an active set to support soft handover. This functionality may be reused such that the transmission timing of the data channel (e.g., HS-PDSCH) communications may be modified to achieve synchronization relating to the interference coordination.

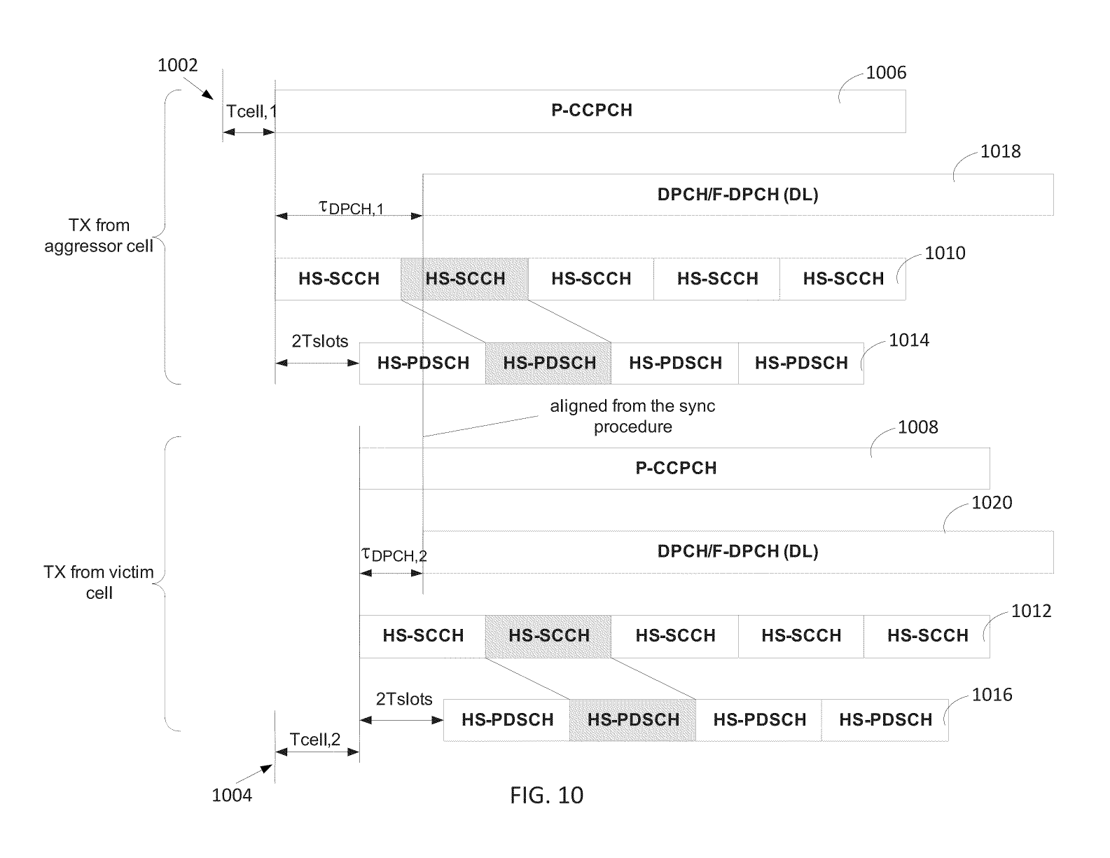

FIG. 10 is a diagram that illustrates an example timing relation of communications from an aggressor cell and a victim cell. As shown in FIG. 10, a transmission from an aggressor cell may begin at a network reference time 1002 for the Node B of the aggressor cell and a transmission from a victim cell may begin at a network reference time 1004 for the Node B of the victim cell. A time T_{cell,1} may indicate the time from the network reference time 1002 at which the P-CCPCH frame 1006 of the aggressor cell transmission may begin. A time T_{cell,2} may indicate the time from the network reference time 1004 at which the P-CCPCH frame 1008 of the victim cell transmission may begin. The T_{cell} parameter that may indicate the starting timing of P-CCPCH may be configured by the network. The control channel (e.g., HS-SCCH) communications 1010 for the aggressor cell and the control channel (e.g., HS-SCCH) communications 1012 for the victim cell may each include a head subframe that is aligned with the P-CCPCH frame 1006 and the P-CCPCH frame 1008, respectively. The data channel (e.g., HS-PDSCH) communications 1014, 1016 may be offset from the control channel communications 1010, 1012. The offset may be 2 time slots.

The transmission timing of the data channel communications 1014 and the data channel communications 1016 may be determined by a time offset parameter τ_{DPCH,1} and τ_{DPCH,2}, respectively. The timing offset parameter τ_{DPCH} may be a timing offset in relation to the DPCH/F-DPCH channel. τ_{DPCH,1} and τ_{DPCH,2} may be a different value when the DPCH/F-DPCH channel 1018 and the DPCH/F-DPCH channel 1020 are not already aligned. When the DPCH/F-DPCH channel 1018 transmitted from the aggressor cell and the DPCH/F-DPCH channel 1020 transmitted from the victim cell are already aligned, by synchronization using τ_{DPCH,1} and τ_{DPCH,2} for example, alignment of data channels 1014, 1016 may be achieved if the network configures this offset parameter according to: |τ_{DPCH,1}−τ_{DPCH,2}|=multiples of 7680 chips, where τ_{DPCH,1} is the timing offset parameter for the aggressor cell and τ_{DPCH,2} is for the victim cell. The difference of the two timing configuration parameters may be an integer number of the subframe duration.

Other forms of synchronization may be performed to provide timing precision for the aggressor cell. The synchronization may be performed using direct WTRU measurements. For example, the WTRU may take measurement of the downlink transmission timing from the HS-PDSCH individually for both cells and may report the difference to the Node B for a fast timing adjustment. The WTRU may take the timing measurement from the CPICH of the aggressor cell and/or the victim cell. The timing difference of the downlink transmissions of the two cells may be calculated based on WTRU measurement. The WTRU measurements may include system frame number (SFN)-SFN, SFN-connection frame number (CFN), and/or the like. If the timing difference is greater than a predefined allowance or threshold, which may be predefined or configured by network, a measurement event may be triggered and/or the value of the difference may be reported to one or both of the Node Bs. The value of the difference may be reported via L1, L2, or higher layer signaling (e.g., via RRC). Upon receiving the measurement report message, the network may indicate to one of the Node Bs to perform the timing adjustment.

The network may indicate to the picocell to change its synchronization, based on the WTRU measurement, such that it may be better aligned with the macrocell. This change of synchronization may be carried out when WTRUs may not be connected to the picocell (e.g., when no WTRUs are connected to the picocell).

Resource restricted CQI measurement and reporting may be performed. The protected subframes, or ABF, may be utilized to schedule data to the WTRU (e.g., a maximum amount of data). A resource restricted CQI measurement may be implemented that reports multiple types of CQIs to the serving cell for downlink scheduling. One type of CQI measurement may be taken during the ABF resource/subframes with good signal quality. Another type of CQI measurement may be calculated/measured during the other transmitted subframes.

To support CQI measurement, the WTRU may be configured by the network through RRC with a single, or a set of, resource restricted measurement patterns. The resource restricted measurement patterns may include the ABF subframes or a subset of the ABF subframes, the non-ABF subframes or a subset of the non-ABF subframes, and/or any other pattern decided by the network. For each CQI type that may be desired by the network, a measurement subframe pattern may be configured by the network. The set of patterns may be signaled to the WTRU in a form of a bit map or equations that the WTRU may use to derive the patterns. The patterns may be derived in real time. A DTX pattern may be configured in the WTRU to deduct the measurement opportunities for different measurements.

Another type of CQI measurement may be taken from the head and tail subframes transmitted in a protected frame period from a victim cell. The CQI measurement may be taken to determine the residual interference resulting from the non-aligned subframe structure. Multiple types of CQI measurements may be reported to the Node B of the victim serving cell.

The multiple types of CQI may be reported in a time division multiplexing fashion. To distinguish the different types of CQI, the CQIs may be arranged in time according to a reporting pattern created from the delayed version of the ABF pattern used for the resource restricted measurement at the WTRU. This delay may account for latency which may be caused by the actual CQI measurement. A set of equations may be defined using CFN as input such that the type of CQI to be transmitted may be determined by satisfying conditions from the set of equations. The control channel (e.g., HS-DPCCH) may be separated into more channels. For example, a two-channel structure may be created by reducing the spread factor. The transmission of CQI type may be made channel specific by allocating a different type to each channel.

Higher layer (e.g., L3) measurement may be performed by a WTRU. Some of the higher layer measurements performed by the WTRU may be affected by the introduction of ABF. A WTRU may perform Radio Resource Management (RRM) related measurements on a limited set of subframes. The limited set of subframes may be indicated to the WTRU by higher layer signaling (e.g., an ABF pattern or in any other form). The resource restriction may be imposed on the RRM related measurements (e.g., RSCP, EcNo, RSSI, etc.) or a subset thereof. In terms of different ABF pattern configurations, the RRM measurement performed at the WTRU may be made towards the serving cell and/or other neighboring cells.

A WTRU may be limited to performing Radio Link Monitoring (RLM) measurements on the resources that are configured with the ABF pattern. When the WTRU is notified of the ABF pattern by RRC, the WTRU may limit its downlink radio link quality monitoring operation to ABFs or a subset of ABFs. The WTRU may not take into account measurements made during an ABF slot. The measurements made during the ABF slot may not be considered for radio link monitoring and/or other mobility/RRM measurements. The WTRU may use the same ABF pattern for the measurements, or some of the measurements. The WTRU may perform various measurements based on different ABF patterns. The use of the ABF pattern may depend on the amount of interference that the WTRU is experiencing and/or the network load.

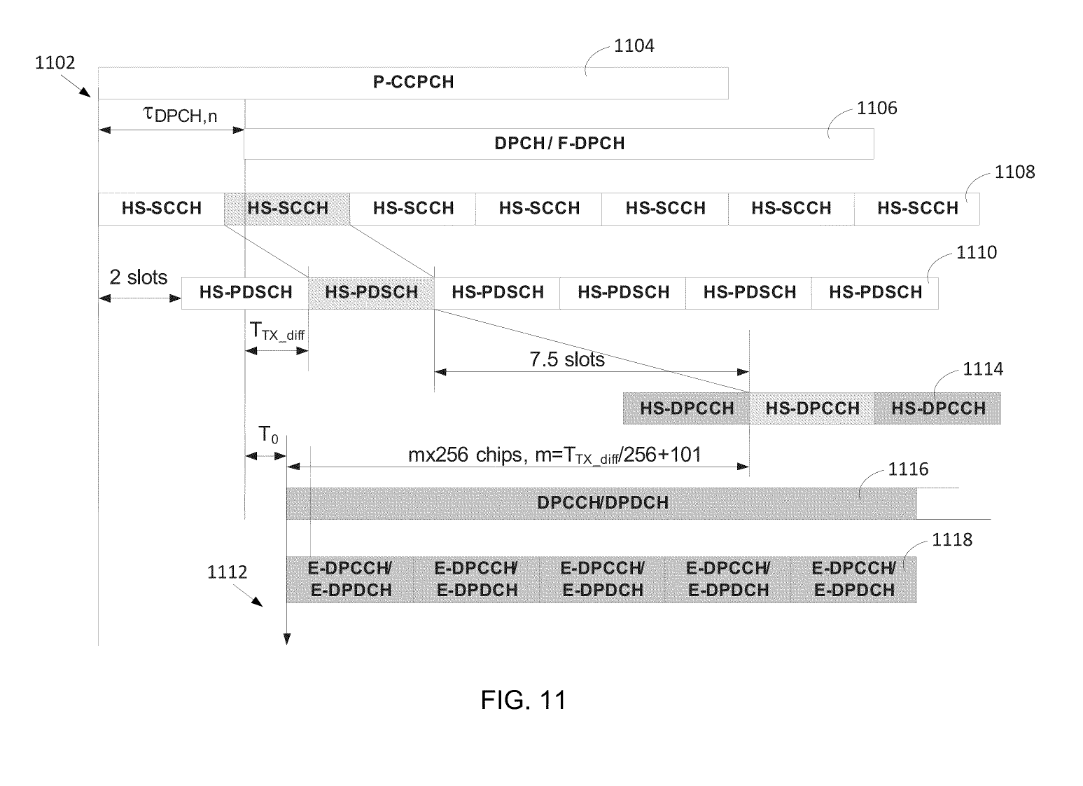

Uplink cross-cell interference, as illustrated in FIGS. 2 and 3, may be avoided by partitioning uplink transmissions in the time domain. FIG. 11 is a diagram that depicts an example of uplink physical channels that may be involved in uplink time partitioning. The uplink channels may include E-DPCCH, E-DPDCH, and/or HS-DPCCH. The diagram depicted in FIG. 11 shows a base timing reference point 1102 from which the uplink (e.g., HS-SCCH) subframes 1108 and the τ_{DPCH,n} may be measured. The P-CCPCH 1104 may begin at the base timing reference point 1102. The DPCH/F-DPCH 1106 may begin at the end of τ_{DPCH,n}. The downlink (e.g., HS-PDSCH) subframes 1110 may be offset from the base timing reference point 1102 or from the subframes of the associated control channel (e.g., HS-SCCH). For example, the offset may be 2 slots.

A subframe of the uplink channel (e.g., HS-DPCCH) 1114 may be offset 7.5 slots from a corresponding subframe of the data channel 1110 (e.g., HS-PDSCH). The subframe of the uplink channel 1114 may be offset to allow an ACK/NACK to be generated for the data on the corresponding subframe of the data channel 1110. The uplink channel (e.g., DPCCH/DPDCH) 1116 and/or the uplink channel (e.g., E-DPCCH/E-DPDCH) 1118 frame timing may be aligned at reference point 1112. Reference point 1112 may be measured from the base timing reference point 1102 with an offset T₀ from τ_{DPCH,n}. The WTRU may transmit on the uplink with an additional value of 1024 chips after reception of the start of the DPCH/F-DPCH 1106 frame timing. T_{TX}_{_{—}}_{diff} may represent the time difference between the DPCH/F-DPCH 1106 frame timing and the closed data channel 1110 subframe.

Time may be partitioned on uplink channel (e.g., E-DPCCH/E-DPDCH) 1118. The WTRU may control transmission of uplink channel (e.g., E-DPCCH/E-DPDCH) 1118 according to different rules and/or sets of parameters depending on whether the subframe belongs to a set of subframes, such as an uplink subframe set. The network may reduce and/or eliminate the inter-cell interference that may be generated by a WTRU in a given serving cell (e.g., a macrocell) during subframes, which may allow WTRUs connected to neighboring serving cells (e.g., picocells) to benefit from lower inter-cell interference during these subframes. For example, an uplink subframe set may correspond to a low-interference set or an almost blank subframe set. The WTRUs in picocells may be configured with activated HARQ processes that may fall during the almost blank subframe set of the aggressor WTRU (e.g., in macro) pattern and/or with deactivated HARQ processes in the non-almost-blank subframes. The network may manage the HARQ processes at the RRC level and/or enable, for the victim WTRU, the HARQ processes to fall under an almost blank subframe.

Uplink subframe sets may be configured as described herein. At least one uplink subframe set may be configured by higher layers. An uplink subframe set may include a subset or pattern of M subframes within a set of N contiguous subframes, which may repeat periodically. An arbitrary pattern of subframes may be defined as being part of a first uplink subframe set, while remaining subframes may be defined as being part of a second uplink subframe set. When a subframe set includes 32 subframes, 20 out of 32 subframes may be part of a first set, while the remaining 12 subframes may be part of a second set. The subframe set to which a subframe belongs may be calculated based on timing parameters, such as CFN, SFN, subframe number, and/or the like. An uplink subframe set may be defined based on the HARQ process of the E-DCH transmission that may be transmitted in the subframe. For example, an uplink subframe set may correspond to processes 0, 4, 5 while another subframe set may correspond to processes 1, 2, 3, 6, 7.

Uplink subframe sets may be configured without E-DPDCH. The WTRU may limit transmission to E-DPCCH/E-DPDCH in subframes belonging to an uplink subframe set. E-DPCCH/E-DPDCH may be prevented from being transmitted in subframes belonging to another uplink subframe set. The uplink subframe set from which E-DPCCH/E-DPDCH may be prevented from being transmitted in may include subframes that correspond to an almost blank subframe set. The WTRU may not create a TB for transmission and/or may perform a HARQ retransmission (e.g., not transmit the E-DPDCH). The WTRU may transmit the E-DPCCH, without the E-DPDCH, with the RSN set as if the E-DPDCH would be transmitted. The WTRU may not transmit the E-DPCCH. The WTRU may increase the value of the RSN for the next retransmission (e.g., the WTRU may update the RSN value even if the E-DPDCH is not transmitted) or not increase the value of the RSN for the next retransmission (e.g., the WTRU may retransmit with the same RSN in the next HARQ process available). If the WTRU increases the value of the RSN for the next retransmission, the increase may be motivated by the fact that the WTRU may maintain synchronous E-DCH HARQ operations.

Because the uplink scheduling may be performed in a distributed manner at each WTRU, each of the WTRUs served by either cell in a multi-cell environment may be involved in the uplink subframe set coordination. To support the interference coordination with the legacy WTRUs, the DTX function in the CPC feature may be reused to implement the blanking operation. The network may configure appropriate DTX parameters, such as WTRU_DTX_cycle_1 and/or WTRU_DTX_cycle_2, to each WTRU served by a cell. The serving cell may use dynamic HS-SCCH orders to control the timing of the DTX operation and/or to achieve the desired uplink subframe set coordination.

WTRUs may be configured with DTX/DRX patterns. The WTRUs configured with DTX/DRX patterns may include non-legacy WTRUs. The DTX/DRX patterns may be in addition to uplink subframe sets. In such cases, the WTRUs may be configured not to transmit E-DPCCH and/or E-DPDCH during uplink subframe set (e.g., corresponding to an almost blank subframe pattern), even if the DTX rules may allow the WTRU to perform an E-DCH transmission and/or retransmission.

Uplink subframe sets may be implemented with reduced E-DPDCH power. The WTRU may assume different maximum power value(s) for different uplink subframe sets. The maximum values may apply to at least one of the total uplink transmission power from each channel, the E-DPDCH/DPCCH power ratio, and/or the E-DPCCH/DPCCH power ratio. The WTRU may maintain different values for different uplink subframe sets, for at least one of the serving grant, the HARQ process activation state for each HARQ process, and/or the grant for non-scheduled transmissions.

As part of the serving grant update procedure, the serving grant associated with a first uplink serving set may be determined from the serving grant associated with a second uplink serving set and/or a fixed offset. The offset may correspond to a number of indices in a serving grant table and/or a value in dB or linear units. The serving grant of a first uplink serving set may be determined to be N dB below the serving grant of a second uplink serving set, where N may be configured by higher layers. The value of the offset may be controlled by an E-AGCH and/or an E-RGCH command applicable to the first uplink serving set. The applicability to a given uplink serving set may be determined as described herein. When the value of the offset is controlled by an E-AGCH and/or an E-RGCH command applicable to the first uplink serving set, the codepoints of E-AGCH (e.g., when applicable to the first uplink serving set) may be interpreted as different offset values instead of different absolute grant values and/or E-RGCH updates may be interpreted as changes in the value of the offset.

An absolute grant received from E-AGCH in a subframe and/or a HARQ deactivation command may be limited to having an effect on the serving grant or HARQ activation status corresponding to one or more uplink subframe set(s). The uplink subframe set(s) may be: the set to which the first uplink subframe affected by this E-AGCH command may belong; a function of the timing of the subframe in which E-AGCH may be received; explicitly signaled in the E-AGCH; a pre-determined (e.g., fixed) uplink subframe set and/or an uplink subframe set configured by higher layers; and/or each of the uplink subframe sets. When the uplink subframe set(s) are explicitly signaled, the E-AGCH codepoints may be re-interpreted compared to other signaling.

A relative grant received from E-RGCH in a subframe may be limited to having an effect on the serving grant corresponding to one or more specific uplink subframe set(s). The uplink subframe set(s) may be: the set to which the first uplink subframe affected by an E-RGCH command may belong; a function of the timing of the subframe in which E-RGCH may be received; a pre-determined (e.g., fixed) uplink subframe set and/or an uplink subframe set configured by higher layers; and/or each of the uplink subframe sets.

Different implementations may be performed depending on whether the E-RGCH is a serving E-RGCH or a non-serving E-RGCH. An update may be performed which may be limited to the serving grant corresponding to a first pre-determined uplink subframe set when a non-serving E-RGCH is received. The uplink subframe set may be based on timing in case a serving E-RGCH is received.

HARQ operation may be performed using uplink subframe sets. A WTRU may be configured with uplink subframe sets and/or may maintain a separate set of HARQ entities associated to each uplink subframe set. A transmission and/or a retransmission in a subframe may be limited to being performed for a HARQ process corresponding to a HARQ entity associated with the uplink subframe set to which it may belong. The set of subframes in which transmissions for a given HARQ process may take place may be calculated based on the patterns defining the uplink subframe sets. The set of subframes associated with a HARQ process may be determined by taking each Pth subframe of the associated uplink subframe set, where P is the number of HARQ processes associated with this subframe set. For example, in case an uplink subframe set includes subframes numbered {0, 1, 2, 4, 6, 8, 9, 10, 12, 14, 17, 18, 19, 20, 22} out of a repeating pattern of 24 subframes, P=5 HARQ processes associated with this uplink subframe set may be defined where the one HARQ process includes subframes {0, 8, 17}, another process includes subframes {1, 9, 18}, and so on.

The DPCCH channel may be transmitted to maintain, in each subframe, the operation of the inner loop power control (ILPC). The DPCCH transmission power may be reduced and/or set to zero during uplink subframe sets. The transmission power may be reduced to further reduce the interference.

To control inter-cell interference, uplink subframe sets may be defined to control HS-DPCCH transmissions and/or DPCCH transmissions in addition to E-DPCCH/E-DPDCH. This may be used if the network may synchronize HS-DPCCH transmissions with E-DPCCH/E-DPDCH transmissions at the subframe level. The sets may include the same, or similar, sets defined for E-DPCCH/E-DPDCH, or may be defined as separate sets.

HS-DPCCH transmissions may be limited to take place on subframes belonging to an uplink subframe set. In this case, transmission of HARQ A/N feedback for HS-DSCH may be performed as described herein. The HS-DPCCH in a subframe belonging to the uplink subframe set where HS-DPCCH transmission is allowed may encode HARQ A/N information pertaining to each downlink subframe for which HARQ A/N information has not been transmitted since the last subframe when HS-DPCCH was transmitted. If there is more than one such downlink subframe, HARQ A/N information may be bundled. An ACK may be limited to being transmitted if each of the downlink transport blocks received in these subframes have been successfully decoded (e.g., on a per-stream and/or per-codeword basis in case of spatial multiplexing). HARQ A/N information may be multiplexed into a single or multiple HS-DPCCH transmission(s) in the same subframe.

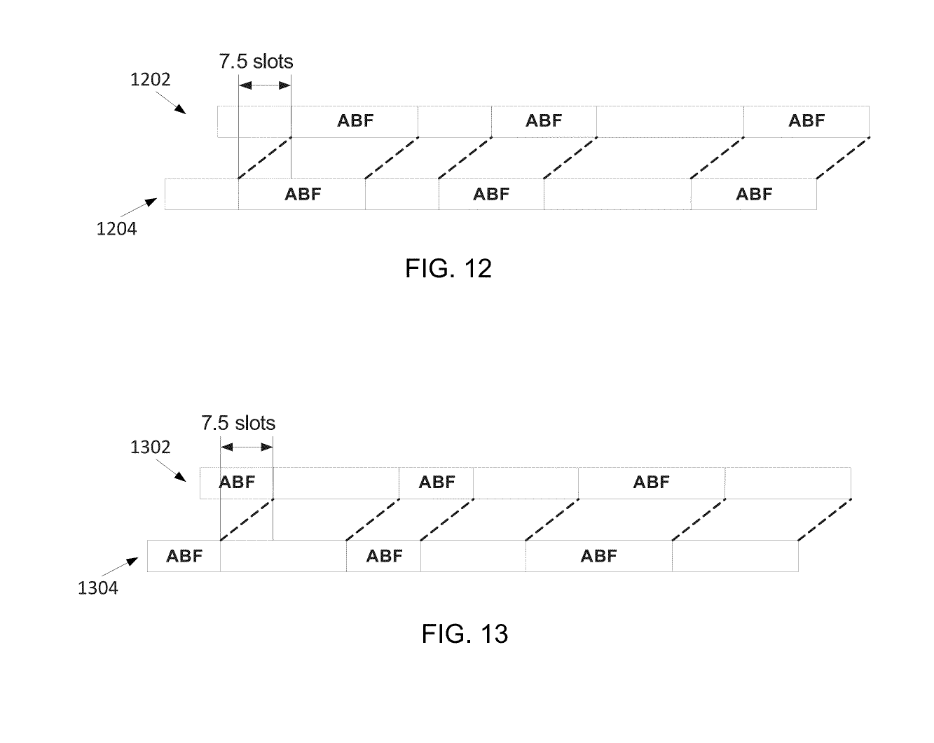

ABF may be coordinated in the uplink and/or the downlink. FIGS. 12 and 13 are diagrams of example subframe configurations that may be implemented for ABF coordination. FIGS. 12 and 13 show coordination of the ABF in uplink communications 1202, 1302 and downlink communications 1204, 1304. Because the uplink communication is related in timing to the downlink communication (e.g., 7.5 slots after the associated downlink subframe), the uplink and downlink ABF patterns may be coordinated to improve the resource partition gain. As shown in FIG. 12, the ABF in the downlink communication 1204 may begin a predetermined period (e.g., 7.5 slots) before the beginning of the ABF of the uplink communication 1202. As shown in FIG. 13, the ABF in the downlink communication 1304 may begin a predetermined period (e.g., 7.5 slots) before the end of the ABF of the uplink communication 1302. Uplink ABFs may be configured with a fixed delay to the downlink ABFs following the timing relation of the uplink channel, as shown in FIG. 12.

Although features and elements are described above in particular combinations, each feature or element can be used alone or in any combination with the other features and elements. Additionally, while features and elements are described in a particular order, these features and elements are not limited to the order described. Further, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, terminal, base station, RNC, or any host computer.

What is claimed:

1. A WTRU for adjusting a transmit power of an uplink control channel, the WTRU comprising:
a processor configured to:
receive a measurement associated a downlink channel for receiving communications from a serving cell;
receive a measurement associated with a downlink channel for receiving communications from a non-serving cell;
determine a difference between the measurement associated with the downlink channel of the serving cell and the measurement associated with the downlink channel of the non-serving cell; and
adjust a transmit power of an uplink control channel for sending control information to the serving cell, wherein the transmit power of the uplink control channel is adjusted based on the determined difference between the measurement associated with the downlink channel of the serving cell and the measurement associated with the downlink channel of the non-serving cell.

2. The WTRU of claim 1, wherein the uplink control channel comprises a High-Speed Dedicated Physical Control Channel (HS-DPCCH).

3. The WTRU of claim 2, wherein at least one of the downlink channel of the serving cell or the downlink channel of the non-serving cell comprises a High Speed Physical Downlink Shared Channel (HS-PDSCH) or a common pilot channel (CPICH).

4. The WTRU of claim 1, wherein the serving cell is a macrocell and the non-serving cell is a picocell or a femtocell.

5. The WTRU of claim 1, wherein the measurement associated with the downlink channel of the serving cell and the measurement associated with the downlink channel of the non-serving cell include at least one of a pathloss, a received signal code power (RSCP), a received signal strength indication (RSSI), a chip-level signal-to-noise ratio (Ec/No), or a chip-level signal-to-interference ratio (Ec/Io).

6. The WTRU of claim 1, wherein the processor is configured to determine the difference based on an offset that compensates for a difference in a Node-B transmit power of the serving cell and a Node-B transmit power of the non-serving cell.

7. The WTRU of claim 1, wherein the processor is configured to adjust the transmit power of the uplink control channel by a predefined amount when the difference between the measurement associated with the downlink channel of the serving cell and the measurement associated with the downlink channel of the non-serving cell exceeds a predefined threshold or is within a predefined range.

8. The WTRU of claim 1, wherein the processor is configured to:
send the difference between the measurement associated with the downlink channel of the serving cell and the measurement associated with the downlink channel of the non-serving cell to a network entity; and
receive an amount to adjust the transmit power of the uplink control channel in response to sending the difference, and
wherein the transmit power of the uplink control channel is adjusted by the received amount.

9. The WTRU of claim 1, wherein the processor is configured to adjust the transmit power of the uplink control channel by increasing the transmit power.

10. A method for adjusting the transmit power of an uplink control channel, the method comprising:
receiving a measurement associated with a downlink channel for receiving communications from a serving cell;
receiving a measurement associated with a downlink channel for receiving communications from a non-serving cell;
determining a difference between the measurement associated with the downlink channel of the serving cell and the measurement associated with the downlink channel of the non-serving cell; and
adjusting a transmit power of an uplink control channel for sending control information to the serving cell, wherein the transmit power is adjusted based on the determined difference between the measurements associated with the downlink channel of the serving cell and the measurements associated with the downlink channel of the non-serving cell.

11. The method of claim 10, wherein the uplink control channel comprises a High-Speed Dedicated Physical Control Channel (HS-DPCCH).

12. The method of claim 11, wherein at least one of the downlink channel of the serving cell or the downlink channel of the non-serving cell comprises a High Speed Physical Downlink Shared Channel (HS-PDSCH) or a common pilot channel (CPICH).

13. The method of claim 10, wherein the serving cell is a macrocell and the non-serving cell is a picocell or a femtocell.

14. The method of claim 10, wherein the measurements associated with the downlink channel of the serving cell and the measurements associated with the downlink channel of the non-serving cell include at least one of a pathloss, a received signal code power (RSCP), a received signal strength indication (RSSI), a chip-level signal-to-noise ratio (Ec/No), or a chip-level signal-to-interference ratio (Ec/Io).

15. The method of claim 10, wherein the difference is determined based on an offset that compensates for a difference in a Node-B transmit power of the serving cell and a Node-B transmit power of the non-serving cell.

16. The method of claim 10, wherein the transmit power of the uplink control channel is adjusted by a predefined amount when the difference between the measurement associated with the downlink channel of the serving cell and the measurement associated with the downlink channel of the non-serving cell exceeds a predefined threshold or is within a predefined range.

17. The method of claim 10, further comprising:
sending the difference between the measurement associated with the downlink channel of the serving cell and the measurement associated with the downlink channel of the non-serving cell to a network entity; and
receiving an amount to adjust the transmit power of the uplink control channel in response to sending the difference, and
wherein the transmit power of the uplink control channel is adjusted by the received amount.

18. The method of claim 10, wherein the transmit power of the uplink control channel is adjusted by increasing the transmit power.
